(19) United States
(12) Patent Application Publication
(10) Pub. No.: US 2025/0106702 A1
(43) Pub. Date: Mar. 27, 2025

(54) METHOD AND APPARATUS FOR CONFIGURING SUBSEQUENT CONDITIONAL PRIMARY SECONDARY CELL ADDITION/CHANGE (S-CPAC)

(71) Applicant: SHARP KABUSHIKI KAISHA, Sakai City (JP)

(72) Inventors: HE-HSUAN LIU, Taipei (TW); Mei-Ju Shih, Taipei (TW); Chia-Hung LIN, Taipei (TW)

(21) Appl. No.: 18/891,332

(22) Filed: Sep. 20, 2024

Related U.S. Application Data
(60) Provisional application No. 63/584,271, filed on Sep. 21, 2023.

(51) Int. Cl. H04W 36/00

(52) U.S. Cl. CPC H04W 36/0061; H04W 36/00835

(57) ABSTRACT

A method for configuring a subsequent conditional primary secondary cell addition/change (S-CPAC) to a UE is provided. The method receives from a source cell an S-CPAC configuration that includes an RRC configuration for a primary secondary cell (PSCell) and a set of conditions for switching to the PSCell. The method receives a secondary key (SK)-counter list associated with the S-CPAC. The list includes one or more SK-counter entries arranged in an order. The method stores the S-CPAC configuration and the SK-counter list. After determining that one or more of the set of conditions are satisfied, the method selects a first SK-counter entry of the SK-counter list and configures the UE with the S-CPAC configuration to switch from another PSCell to the PSCell. In configuring the UE with the S-CPAC configuration, the first SK-counter entry is applied. The method then removes the first SK-counter entry from the SK-counter list.

### CLAIM OF BENEFIT TO PRIOR APPLICATION(S)

The present disclosure claims the benefit of and priority to U.S. Provisional Patent Application Ser. No. 63/584,271, filed on Sep. 21, 2023, entitled “METHOD AND APPARATUS FOR SUBSEQUENT CONDITIONAL PSCELL ADDITION AND/OR CHANGE,” the content of which is hereby incorporated herein fully by reference into the present disclosure for all purposes.

### TECHNICAL FIELD

The technology generally relates to wireless communications, and more specifically, to methods and apparatuses for mobility management by configuring primary secondary cell (PSCell) addition/change (S-CPAC).

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems, such as improvements in the network mobility management.

### SUMMARY

In a first aspect of the present application, a method for configuring a subsequent conditional primary secondary cell addition/change (S-CPAC) to a user equipment (UE) is provided. The method includes receiving an S-CPAC configuration from a source cell, the S-CPAC configuration includes a radio resource control (RRC) configuration for a primary secondary cell (PSCell) and a set of conditions for switching to the PSCell; receiving a secondary key (SK)-counter list associated with the S-CPAC, the SK-counter list includes one or more SK-counter entries arranged in an order in the SK-counter list; storing the S-CPAC configuration and the SK-counter list; and after determining that one or more conditions in the set of conditions are satisfied: selecting a first SK-counter entry of the SK-counter list, configuring the UE with the S-CPAC configuration to switch from another PSCell to the PSCell, where the first SK-counter entry is applied in configuring the UE with the S-CPAC configuration, and removing the first SK-counter entry from the SK-counter list.

In an implementation of the first aspect, the source cell includes one of a primary cell (PCell) of a master node (MN) or the other PSCell of a secondary node (SN).

In another implementation of the first aspect, receiving the SK-counter list includes receiving an information element (IE) that includes the SK-counter list and an identifier (ID) that identifies the SK-counter list.

In another implementation of the first aspect, the S-CPAC configuration and the IE are received in a same radio resource control (RRC) message.

In another implementation of the first aspect, the S-CPAC configuration and the IE are received in separate RRC messages.

In another implementation of the first aspect, applying the first SK-counter entry in configuring the UE with the S-CPAC configuration includes deriving an SK based on a value of the first SK-counter entry. The UE encodes data transmitted to the PSCell and decodes data received from the PSCell using the SK.

Another implementation of the first aspect, where the S-CPAC configuration is a first S-CPAC configuration, the PSCell is a first PSCell, the set of conditions is a first set of conditions, and the SK-counter list is a first SK-counter list, further includes receiving a second S-CPAC configuration from the source cell, the second S-CPAC configuration includes another RRC configuration for a second PSCell and a second set of conditions for switching to the second PSCell; receiving a second SK-counter list associated with the second S-CPAC, the second SK-counter list includes one or more SK-counter entries arranged in the order in the second SK-counter list; storing the second S-CPAC configuration and the second SK-counter list; and after determining that one or more conditions in the second set of conditions are satisfied: selecting a first SK-counter entry of the second SK-counter list, configuring the UE with the second S-CPAC configuration to switch from the first PSCell to the second PSCell, where the first SK-counter entry of the second SK-counter list is applied in configuring the UE with the second S-CPAC configuration, and removing the first SK-counter entry of the second SK-counter list from the second SK-counter list.

In another implementation of the first aspect, the first PSCell and the second PSCell belong to two different SNs.

Another implementation of the first aspect further includes determining that one or more conditions in the first set of conditions are satisfied; selecting a second SK-counter entry of the first SK-counter list, where the second SK-counter entry is a next entry, in the order, after the removed first SK-counter entry in the first SK-counter list; switching from the second PSCell back to the first PSCell, where the UE applies the second SK-counter entry of the first SK-counter list when the UE is configured back based on the first S-CPAC configuration; and removing the second SK-counter entry of the first SK-counter list from the first SK-counter list.

In a second aspect of the present application, a method for a UE that is capable of being configured with both a conditional primary secondary cell addition/change (CPAC) and an S-CPAC is provided. The method includes receiving a CPAC configuration and an S-CPAC configuration from a source cell; storing the CPAC configuration and the S-CPAC configuration in a storage of the UE; evaluating one or more conditions for configuring the UE with the CPAC configuration or the S-CPAC configuration; in a case that at least one condition, from the one or more conditions, for configuring the UE with the S-CPAC configuration is met: configuring the UE with the S-CPAC configuration, and maintaining the stored S-CPAC configuration and the stored CPAC configuration; and in a case that at least one condition, from the one or more conditions, for configuring the UE with the CPAC configuration is met: configuring the UE with the CPAC configuration, maintaining the stored S-CPAC configuration in the storage, and removing the stored CPAC configuration from the storage.

In an implementation of the second aspect, the CPAC configuration and the S-CPAC configuration are associated with a PSCell of an SN.

In another implementation of the second aspect, the CPAC configuration is associated with a first PSCell of a first SN and the S-CPAC configuration is associated with a second PSCell of a second SN.

Another implementation of the second aspect further includes prior to receiving the CPAC and S-CPAC configurations from the source cell, transmitting a message to the source cell indicating that the UE is capable of being configured with both the CPAC and the S-CPAC at a same time.

In another implementation of the second aspect, the S-CPAC configuration and the CPAC configuration are received in an RRC message from the source cell.

In another implementation of the second aspect, the S-CPAC configuration and the CPAC configuration are received from the source cell via separate radio RRC messages.

In another implementation of the second aspect, the source cell includes one of a PCell of a MN or a PSCell of a SN.

In a third aspect, a UE is provided. The UE includes one or more non-transitory computer-readable media that are coupled to at least one processor. The one or more non-transitory computer-readable media store one or more computer-executable instructions for configuring an S-CPAC to the UE. The one or more computer-executable instructions, when executed by the at least one processor, cause the UE to receive an S-CPAC configuration from a source cell, the S-CPAC configuration including an RRC configuration for a PSCell and a set of conditions for switching to the PSCell; receive a SK-counter list associated with the S-CPAC, the SK-counter list includes one or more SK-counter entries arranged in an order in the SK-counter list; store the S-CPAC configuration and the SK-counter list; and after determining that one or more condition in the set of conditions are satisfied: select a first SK-counter entry of the SK-counter list, configure the UE with the S-CPAC configuration to switch from another PSCell to the PSCell, where the first SK-counter entry is applied in configuring the UE with the S-CPAC configuration, and remove the first SK-counter entry from the SK-counter list.

In an implementation of the third aspect, applying the first SK-counter entry in configuring the UE with the S-CPAC configuration includes deriving an SK based on a value of the first SK-counter entry, where the UE encodes data transmitted to the PSCell and decodes data received from the PSCell using the SK.

In another implementation of the third aspect, the S-CPAC configuration is a first S-CPAC configuration, the PSCell is a first PSCell, the set of conditions is a first set of conditions, and the SK-counter list is a first SK-counter list, and the at least one processor is further configured to execute the one or more computer-executable instructions to cause the UE to receive a second S-CPAC configuration from the source cell, the second S-CPAC configuration includes another RRC configuration for a second PSCell and a second set of conditions for switching to the second PSCell; receive a second SK-counter list associated with the second S-CPAC, the second SK-counter list includes one or more SK-counter entries arranged in the order in the second SK-counter list; store the second S-CPAC configuration and the second SK-counter list; and after determining that one or more conditions in the second set of conditions are satisfied: select a first SK-counter entry of the second SK-counter list, configure the UE with the second S-CPAC configuration to switch from the first PSCell to the second PSCell, where the first SK-counter entry of the second SK-counter list is applied in configuring the UE with the second S-CPAC configuration, and remove the first SK-counter entry of the second SK-counter list from the second SK-counter list.

In another implementation of the third aspect, the at least one processor is further configured to execute the one or more computer-executable instructions to cause the UE to determine that one or more conditions in the first set of conditions are satisfied; select a second SK-counter entry of the first SK-counter list, where the second SK-counter entry is a next entry, in the order, after the removed first SK-counter entry in the first SK-counter list; switch from the second PSCell back to the first PSCell, where the UE applies the second SK-counter entry of the first SK-counter list when the UE is configured back based on the first S-CPAC configuration; and remove the second SK-counter entry of the first SK-counter list from the first SK-counter list.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIGS. 1A and 1B are operational diagrams illustrating an example radio communication system that supports S-CPAC for inter-SN UE mobility events, according to an example implementation of the present disclosure.

FIGS. 2A and 2B are operational diagrams illustrating an example radio communication system that supports S-CPAC for intra-SN UE mobility events, according to an example implementation of the present disclosure.

FIG. 3 is a flowchart illustrating an example method/process performed by a UE for configuring an S-CPAC to the UE, according to an example implementation of the present disclosure.

FIG. 4 is a flowchart illustrating an example method/process performed by a UE for simultaneously configuring CPAC and S-CPAC, according to an example implementation of the present disclosure.

FIG. 5 is a block diagram illustrating a node for wireless communication, according to an example implementation of the present disclosure.

### DETAILED DESCRIPTION

Some of the abbreviations in the present application are defined as follows and, unless otherwise specified, the abbreviations have the following meanings:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| LSB | Least Significant Bit |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NES | Network Energy Saving |
| NPN | Non-Public Network |
| NR | New Radio |
| NR-U | NR Unlicensed |
| NTN | Non-Terrestrial Network |
| PA | Power Amplifier |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PMI | Precoding Matrix indicator |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| RE | Resource Element |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SSS | Secondary Synchronization Signal |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TRX | Transmission/Reception |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the Primary Cell (PCell) and zero or more secondary cells. Conversely, the SCG may be a set of one or more serving cells including the PSCell and zero or more secondary cells.

As also described above, the PCell may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Multiple Public Land Mobile Networks (PLMNs) may be operated on the unlicensed spectrum. Multiple PLMNs may share the same unlicensed carrier. The PLMNs may be public or private. Public PLMNs (e.g., provided by operators and/or virtual operators) may provide radio services to public subscribers. Public PLMNs may own licensed spectrum and also support radio access technology on the licensed spectrum. Private PLMNs (e.g., provided by micro-operators, factories, and/or enterprises) may provide radio services to their private users (e.g., employees or machines). In some implementations, public PLMNs may support more deployment scenarios. These scenarios may include carrier aggregation between licensed band NR (e.g., the PCell) and NR Unlicensed (NR-U) (e.g., the SCell), dual connectivity between licensed band LTE (e.g., the PCell) and NR-U (e.g., the PSCell), stand-alone NR-U, an NR cell with DL in the unlicensed band and UL in the licensed band, and dual connectivity between licensed band NR (e.g., the PCell) and NR-U (e.g., the PSCell). In some implementations, private PLMNs mainly support, but are not limited to, stand-alone unlicensed radio access technology, such as stand-alone NR-U.

The terms, definitions, and abbreviations included in the present disclosure are either sourced from existing documents (such as those from European Telecommunications Standards Institute (ETSI), International Telecommunication Union (ITU), or other sources) or newly created by experts from the 3GPP whenever there was a need for precise vocabulary.

Examples of some selected terms in the present disclosure are provided as follows.

The terms “network (NW),” “cell,” “camped cell,” “serving cell,” “BS,” “gNB,” “eNB” and “ng-eNB” may be used interchangeably. In some implementations, some of these items may include the same network entity.

A radio access technology (RAT) may include, but is not limited to, an NR, an LTE, an E-UTRA connected to the 5GC, an LTE connected to the 5GC, E-UTRA connected to EPC, and an LTE connected to the EPC. The mechanisms, methods, and/or approaches described in the present disclosure may be applicable to the UEs operating in the public networks or in the private networks (e.g., non-public networks (NPNs), stand-alone non-public networks (SNPNs), and/or public network integrated non-public networks (PNI-NPNs)).

The mechanisms, methods, and/or approaches described in the present disclosure may be applicable to the licensed frequency and/or the unlicensed frequency. In addition, the mechanism of conditional configuration selection described in the present disclosure may be applied for the cases in which a UE experiences a radio link failure when configured with the conditional configuration(s).

System information (SI) may include the Master Information Block (MIB), the System Information Block 1 (SIB1), or other system information (SI). Minimum SI may include the MIB and the SIB1. Other SI may include SIB3, SIB4, SIB5, or other SIB(s). It should be noted that the system information may be associated with the serving cell and/or the system information may be associated with the target cell.

Dedicated signaling may include, but is not limited to, one or more RRC messages. Examples of the RRC signaling or RRC message(s) may include the RRC (Connection) Setup Request message, the RRC (Connection) Setup message, the RRC (Connection) Setup Complete message, the RRC (Connection) Reconfiguration message, the RRC Connection Reconfiguration message including the mobility control information, the RRC Connection Reconfiguration message without the mobility control information inside, the RRC Reconfiguration message including the configuration with sync, the RRC Reconfiguration message without the configuration with sync inside, the RRC (Connection) Reconfiguration Complete message, the RRC (Connection) Resume Request message, the RRC (Connection) Resume message, the RRC (Connection) Resume Complete message, the RRC (Connection) Reestablishment Request message, the RRC (Connection) Reestablishment message, the RRC (Connection) Reestablishment Complete message, the RRC (Connection) Reject message, the RRC (Connection) Release message, the RRC System Information Request message, the UE Assistance Information message, the UE Capability Enquiry message, and UE Capability Information message.

The mechanisms, methods, and/or approaches described in the present disclosure may be applicable to the RRC_CONNECTED UE (e.g., the UE in the RRC_CONNECTED state), the RRC_INACTIVE UE (e.g., the UE in the RRC_INACTIVE state), and the RRC_IDLE UE (e.g., the UE in the RRC_IDLE state).

A source cell may include a suitable cell or an acceptable cell.

The UE may be served by a cell, e.g., a serving cell. The serving cell may serve an RRC_CONNECTED UE, among other types of UEs. The serving cell may include, but is not limited to, a suitable cell.

PCell: an MCG cell, operating on the primary frequency, in which the UE either performs the initial connection establishment procedure or initiates the connection reestablishment procedure.

PSCell: an SCG cell used for dual connectivity operation, in which the UE may perform an RA procedure when performing the Reconfiguration with the synchronization (Sync) procedure.

Serving Cell: for a UE in the RRC_CONNECTED state not configured with CA/DC, there is only one serving cell consisting of the primary cell. For a UE in the RRC_CONNECTED state configured with CA/DC, the term “serving cells” is used to denote the set of cells consisting of the Special Cell(s) and all secondary cells.

Secondary Cell: for a UE configured with CA, the secondary cell may include the cell that provides additional radio resources on top of the Special Cell.

SpCell: for the DC operation, the Special Cell may include the PCell of the MCG or the PSCell of the SCG, otherwise the Special Cell may include the PCell.

MCG: in MR-DC, the MCG may include a group of serving cells associated with the MN, consisting of the SpCell (e.g., the PCell) and optionally one or more SCells.

MN: in MR-DC, the MN may include the radio access node that provides the control plane connection to the core network. The MN may include a Master eNB (in EN-DC), a Master ng-eNB (in NG-RAN E-UTRA-NR Dual Connectivity (NGEN-DC)), or a Master gNB (in New Radio-Dual Connectivity (NR-DC) and NR-E-UTRA Dual Connectivity (NE-DC)).

SCG: in MR-DC, the SCG may include a group of serving cells associated with the SN, consisting of the SpCell (e.g., the PSCell) and optionally one or more SCells.

SN: in MR-DC, the SN may include the radio access node, with no control plane connection to the core network, providing additional resources to the UE. The SN may include an en-gNB (in EN-DC), a Secondary ng-eNB (in NE-DC) or a Secondary gNB (in NR-DC and NGEN-DC). en-gNB is a node providing NR user plane and control plane protocol terminations towards the UE, and acting as an SN in EN-DC.

The serving cell described in the present disclosure may include a PCell, an SCell, or a PSCell.

The source node described in the present disclosure may include at least one of the following: a source MN, a source SN, a source gNB, a source eNB, a source PCell, a source PSCell, and a source SCell.

In the present disclosure, the terms “secondary key counter” (“SK counter”), “SK-Counter,” and “SN counter” may be used interchangeably. In present disclosure, the terms “SN security key,” “KSN,”, “S-KeNB” and “S-KgNB” may be used interchangeably. It should be noted that the SK-counter may be a counter used upon initial configuration of SN security for NR-DC, NGEN-DC, and NE-DC, as well as upon refresh of S-KgNB or S-KeNB based on the current or newly derived KgNB (e.g., master key) during RRC Resume or RRC Reconfiguration.

The target cell described in the present disclosure may include a PCell, an SCell, or a PSCell.

The inter-cell relative to the serving cell of the UE may include a neighboring cell, a cell other than the serving cell or a cell with a PCI different from the PCI of the serving cell. If the UE is capable of performing inter-cell beam managements, the UE may be in the coverage area of the inter-cell.

An RRC_CONNECTED UE may be configured with an active Bandwidth Part (BWP) with a common search space configured to monitor the system information or the paging.

The UE may be served by a cell (e.g., serving cell). The serving cell may serve, but not limited to, an RRC_CONNECTED UE. The serving cell may include, but is not limited to, a suitable cell.

The UE may camp on a cell referred to as a camped cell. The camped cell may be a suitable cell or an acceptable cell. A suitable cell may include a cell on which a UE may camp. The UE may consider a cell as a suitable cell if the following conditions are fulfilled: (1) the cell is part of either the selected PLMN or the registered PLMN or the PLMN of the equivalent PLMN list, and (2) the cell criteria of the cell are fulfilled. Furthermore, according to the latest information provided by the Non-Access Stratum (NAS), the suitable cell may not be barred. The suitable cell may be part of at least one Tracking Area (TA) that is not part of the list of “Forbidden Tracking Areas,” which belongs to the PLMN that fulfils the condition (1). The target cell may include a suitable cell.

An acceptable cell may include a cell on which the UE may camp to obtain the limited services (e.g., originate emergency calls and receptions of Earthquake and Tsunami Warning System (ETWS) and Commercial Mobile Alert System (CMAS) notifications). Such a cell may fulfil the following requirements, which is the minimum set of requirements to initiate an emergency call and to receive ETWS and CMAS notification in an NR network: (1) the cell is not barred, and/or (2) the cell selection criteria are fulfilled.

The candidate target MN may include the MN associated with the candidate target PCells.

The candidate target SN may include the SN associated with the candidate target PSCells.

A Conditional Primary Secondary Cell Addition and/or Change (CPAC) may include a Conditional Primary Secondary Cell Addition (CPA), a Conditional Primary Secondary Cell Change (CPC), or both.

It should be noted that a CPAC configuration may be an IE (e.g., carried in an RRC message) or may be a variable (e.g., stored in the UE). A CPAC configuration may include a conditional configuration ID (e.g., condReconfigId), one or more execution conditions (e.g., measId), and an RRC configuration (e.g., RRCReconfiguration) to be applied when the execution condition(s) are satisfied.

It should be noted that an S-CPAC configuration may be an IE (e.g., carried in an RRC message) or may be a variable (e.g., stored in the UE). The S-CPAC configuration may include a conditional configuration ID (e.g., condReconfigId), one or more execution conditions (e.g., measId), an RRC configuration (e.g., the RRCReconfiguration) to be applied when the execution condition(s) are satisfied, and a list of execution conditions (e.g., the meadId) to be applied to substitute execution condition(s) in other S-CPAC configurations when the execution condition(s) included in the S-CPAC configuration are satisfied.

In some embodiments, a UE may differentiate the S-CPAC configurations from the legacy CPAC configurations by identifying the name of the IE carrying the configuration parameters. For example, an S-CPAC configuration may be assigned a first type of naming whereas the CPAC configuration may be assigned a second type of naming.

A single Selective Activation (SA) counter may be associated to a PSCell, an SCG configuration, multiple PSCells, and/or multiple SCG configurations.

The inter-node signaling (e.g., between the MN and the SN), in some embodiments, may include the RRC signaling or the Xn Application Protocol (XnAP) signaling.

In the present disclosure, although the term “gNB” is used in the document, it should be understood that the term “gNB” may be replaced by any other type of BS (e.g., an eNB).

In wireless cellular networks, the MR-DC may enable one or more mobile devices (e.g., one or more UEs) to connect to at least two network nodes, such as an MN and at least one SN. The MN and/or the SN may include one or more cells, and the network may configure a mobile device with a group of cells called MCG in the MN and another group of cells called SCG in the SN. It is possible that the network may include one MN and at least one SN, which means that the mobile device may be configured with one MCG and at least one SCG, where each SCG is in the SN. The mobile device may exchange the control and user data with both the PCell and the PSCell.

The mobile devices may move from one cell to another due to their mobility. When a mobile device moves from a serving cell to a neighboring cell, a mobility event may occur. For example, the quality of the signal received from the source cell may fall below a threshold for a period. A handover procedure may then be needed to ensure that the mobile device is able to continue the ongoing service in the neighboring cell. Typically, the handover procedure may be triggered by L3 measurements and is completed with RRC signaling. The neighboring cell may include a cell close to the source cell. For a mobile device, it is possible that the mobility event for the PSCell may occur, whereas the mobility event for the PCell may not occur. In such cases, the mobile device may change the PSCell while maintaining the connection to the serving PCell, and the procedure may be called a PSCell change or a PSCell change procedure.

The PSCell change procedure may be further enhanced to become a CPC or a CPC procedure. In the CPC procedure, a mobile device may be configured (e.g., through multiple CPC configurations) with multiple candidate target PSCell configurations and the execution conditions corresponding to the candidate target PSCell configurations. Once an execution condition is satisfied, the mobile device may apply the corresponding PSCell configuration to construct the connection to the target PSCell. After executing one of the CPC configurations, the mobile device should release all of the stored CPC configurations.

In addition to the CPC procedure, there is also a conditional procedure for the MR-DC operation, referring to as a CPA or a CPA procedure. For a mobile device operating in the standalone mode (e.g., the mobile device is only connecting to the MN), the network may configure the UE with multiple candidate PSCells, which may belong to different SNs, and the execution conditions corresponding to the candidate PSCells, through multiple CPA configurations. Once an execution condition is satisfied, the mobile device may apply the corresponding PSCell configuration to establish the connection to the target PSCell and start operating in the MR-DC. Similar to the CPC procedure, the mobile device should release all of the stored CPA configurations.

An executed CPC configuration may retain the same SCG configuration as the one which was configured and released in the previous CPC. For example, a UE may be configured with two CPC configurations towards PSCell 1 and PSCell 2. After the UE executes the CPC towards PSCell 1, both CPC configurations may be released. As the channel quality varies, the UE may then be configured with other CPC configurations towards PSCell 2 and PSCell 3. In the example, the SCG configuration of PSCell 2 may be the same in the first and the second CPC evaluations, but it might have been released, and must be reconfigured again. As such, the release and the reconfiguration could cause signaling overhead. To reduce signaling overhead for the reconfiguration, the UE may keep the stored CPA or CPC configurations upon every CPA or CPC execution. Such a scenario may be called a subsequent CPA and/or CPC (S-CPAC) procedure.

A CPAC (or a CPAC procedure) with an SCG selective activation may include, but is not limited to, an initial CPAC preparation step with the SCG selective activation and multiple subsequent CPAC evaluation and execution steps. During the CPAC evaluation and execution step, the UE may perform evaluation to determine whether to execute the CPAC. In some implementations, the initial preparation step may include the initial CPAC with the SCG selective activation preparation step, and the initial preparation may include the initial CPAC with the SCG selective activation preparation. For example, the preparation may include determining the radio resource configuration for the candidate PSCell/SCG and performing the signaling exchange to facilitate the determination of the radio resource configuration. The CPAC with the SCG selective activation may be used to reduce the reconfigurations of the CPAC candidate(s) by allowing the UE to retain the stored CPAC candidate configuration(s) after executing the CPAC. The terms “CPAC procedure with the SCG selective activation” and “CPCSA” may be utilized interchangeably in the present disclosure.

In the present disclosure, the following scenario may be considered: a network includes multiple cells, and a UE supports the MR-DC configuration. This means that the UE is able to receive service data from at least two RAN nodes, for example, an MN including an MCG and at least one SN including an SCG. In the present disclosure, the terms “MN” and “master gNB” may be utilized interchangeably and the terms “SN” and “secondary gNB” may be utilized interchangeably. The UE may be configured with multiple receivers and transmitters and may be capable of supporting the MR-DC-dedicated configurations. The network, being aware of the UE's capabilities, may configure the UE with an MR-DC configuration (e.g., the SCG configuration) that is encapsulated in an RRC reconfiguration message and that is transmitted from the serving gNB/cell to the UE. In this scenario, the UE may operate with the MR-DC configuration if the MR-DC is configured by the network, or may not operate with the MR-DC configuration if the MR-DC is not configured by the network.

If the UE is configured with the MR-DC and is operating with the MR-DC configuration, the network may utilize the radio resources provided by two distinct schedulers located in different RAN nodes. The UE may maintain the control and user plane connections with the PCell in the MCG and the PSCell in the SCG. From the UE's perspective, there may be three types of bearers for the user plane: the MCG bearer, the SCG bearer, and the split bearer. From the network's perspective, each bearer may terminate either in the MN or the SN.

In the existing S-CPAC procedure, there are issues to be solved or to be optimized. For example, a UE needs to update an SN security key (may also be referred to as secondary key) upon an inter-SN change or needs to acquire an SN security key upon an SN addition. The SN security key may be used to encrypt the control and user data exchange with the SN. The SN security configuration in legacy CPA and/or CPC procedure may not be applicable in the S-CPAC procedure. As another example, how to configure the execution conditions for the S-CPAC has not been determined by the existing 3GPP procedures. The current RRC IE structure may not be able to accommodate the information of execution conditions for the S-CPAC. Moreover, in some special cases, the UE may stop the evaluation of S-CPAC execution conditions. Therefore, how to trigger the UE to restart the evaluation in such cases needs to be designed. The present disclosure addresses the aforementioned problems which are possibly encountered by the S-CPAC, such as the SK-counter configuration, S-CPAC execution condition configuration, and the trigger of resumption of the evaluation of S-CPAC execution conditions.

### Subsequent CPAC Procedure

S-CPAC is a procedure involving, but not limited to, an initial S-CPAC preparation step, multiple subsequent alternate S-CPAC evaluation steps, and multiple S-CPAC execution steps. The goal of S-CPAC is to reduce the reconfigurations of CPAC candidates by allowing the UE to keep/maintain the stored S-CPAC candidate configuration(s) after the UE executes an S-CPAC or, if configured, a CPAC.

An S-CPAC configuration may be associated with a PSCell. An S-CPAC configuration may include a conditional configuration ID, one or more execution conditions for the associated PSCell, and an RRC reconfiguration which the UE may apply in a case that the execution condition(s) for the associated PSCell is/are satisfied. A UE may distinguish between an S-CPAC configuration and a CPAC configuration according to the naming of the corresponding information elements (IEs).

### UE Capability for Supporting S-CPAC

A UE, in some embodiments, may report its capability related to supporting S-CPAC to the source node (e.g., the source MN/SN) via RRC signaling (e.g., via UECapabilityInformation IE/message). The UE may report its capability related to supporting S-CPAC to the source cell in response to the reception of RRC signaling (e.g., UECapabilityEnquiry message) from the source cell.

The format in the RRC signaling corresponding to the capability report of supporting the S-CPAC may be ENUMERATED {support}, ENUMERATED {support, not support}, or ENUMERATED {S-CPAC}. If the UE indicates “support” or “S-CPAC”, the UE may indicate its capability of supporting the S-CPAC. If the field is absent or “not support”, the UE may indicate that the UE does not support the S-CPAC.

In some of the embodiments that a UE supports the S-CPAC, the UE may be configured to report the maximum number of S-CPAC configurations. In some of the embodiments that the UE supports S-CPAC, the UE may be configured to report the maximum number of all conditional configurations (e.g., the Conditional Handover (CHO) configurations, the CHO with candidate SCG configurations, the CPAC configurations, and the S-CPAC configurations). In some of the embodiments that the UE supports S-CPAC, the UE may be configured to report the maximum number of the sum of all conditional configurations (e.g., the CHO configurations, the CHO with candidate SCG configurations, the CPAC configurations, and the S-CPAC configurations) and the L1/L2 triggered mobility (LTM) configurations. In some of the embodiments that a UE supports the S-CPAC, the UE may be configured to report one or more pairs of a maximum number of all conditional configurations (e.g., the CHO configurations, the CHO with candidate SCG configurations, the CPAC configurations, and the S-CPAC configurations) and a maximum number of LTM configurations.

In some embodiments, the UE may report, to the source node (e.g., the source MN/SN) via RRC signaling (e.g., via UECapabilityInformation IE), its capability of whether it supports the S-CPAC and CPAC configurations at the same time. The format in the RRC signaling corresponding to the capability report of supporting S-CPAC and CPAC configurations simultaneously may be ENUMERATED {enabled}, ENUMERATED {enabled, disabled}, ENUMERATED {simultaneous}, or ENUMERATED {CPAC, S-CPAC, both}. If the field is “enabled”, “simultaneous” or “both”, the UE may indicate its capability of supporting the S-CPAC and CPAC configurations at the same time. If the field (e.g., ENUMERATED {simultaneous} or ENUMERATED {enabled}) is absent, the UE may indicate that it does not support the S-CPAC and CPAC configurations at the same time. If the field is “CPAC”, the UE may indicate its capability of supporting the CPAC, but not the S-CPAC. If the field is “S-CPAC”, the UE may indicate its capability of supporting the S-CPAC, but not the CPAC. If the field is “disabled” or the field (e.g., ENUMERATED {CPAC, S-CPAC, both}) is absent, the UE may indicate that it does not support the S-CPAC and CPAC configurations at the same time.

In some of the embodiments that a UE supports simultaneous configurations of the S-CPAC and CPAC, the UE may be configured (at the same time) to report one or more pairs of a maximum number of S-CPAC configurations and a maximum number of CPAC configurations. In some of the embodiments that the UE supports simultaneous configurations of the S-CPAC and CPAC, the UE may report the maximum number of the sum of S-CPAC and CPAC configurations.

In some embodiments, if a UE supports the S-CPAC and reports the S-CPAC support capability to the source node (e.g., the source MN/SN), upon receiving the S-CPAC configurations from the source node (e.g., the source MN/SN), for example, via RRC messages (e.g., RRC Reconfiguration message), the UE may store the received S-CPAC configurations.

In some embodiments, if a UE does not support the S-CPAC, upon receiving the S-CPAC configurations from the source node (e.g., the source MN/SN) via RRC messages, the UE may discard the received S-CPAC configurations.

In some embodiments, if a UE does not support the S-CPAC, upon receiving S-CPAC configurations from the source node (e.g., the source MN/SN) via RRC messages, the UE may discard the received S-CPAC configurations and may perform a reconfiguration failure procedure with the source MN or source SN.

In some embodiments, if a UE supports the S-CPAC, but does not report the S-CPAC support capability to the source node (e.g., the source MN/SN) via RRC signaling (e.g., via UECapabilityInformation IE), upon receiving the S-CPAC configurations from the source node (e.g., the source MN/SN) via RRC messages, the UE may discard the received S-CPAC configurations.

### Sk-Counter List Configuration

In some embodiments, upon executing the CPA and/or inter-SN CPC to a new PSCell, a UE may derive the SN security key from an SN counter (e.g., configured SK-counter), the value of which may be configured in the CPA and/or CPC configuration. In some implementations, after deriving the SN security key, the UE may start to use the derived SN security key to derive the SN RRC key and the SN UP key, which are responsible for the ciphering and deciphering of the control plane signaling and user plane data between the UE and the new SN.

### Sk-Counter List Configuration Method 1—Sk-Counter Id Linking SK-Counter List to a Group of Cells

In some embodiments, the source node (e.g., the source MN/SN) may configure the UE with an IE, referred to herein as the “sk-counterSetToAddMod IE,” which is associated with at least the information/configuration associated with the SK-counter, via an RRC reconfiguration IE/message.

The sk-counterSetToAddMod IE and the S-CPAC configurations, in some embodiments, may be configured to the UE via different RRC messages. In other embodiments, the sk-counterSetToAddMod IE and the S-CPAC configurations may be configured to the UE via the same RRC message.

The sk-counterSetToAddMod IE, in some embodiments, may contain an IE, referred to herein as the “SK-CounterSetID IE,” which the UE may use to identify the corresponding sk-counterSetToAddMod IE. In some embodiments, the SK-CounterSetID IE may take integer values from 1 to the number of configured sk-counterSetToAddMod IEs.

The sk-counterSetToAddMod IE, in some embodiments, may contain an IE, referred to herein as the “SK-CounterList IE,” which includes a list of SK-Counter IEs. In some embodiments, an SK-Counter IE may take an integer value, and a UE may use the value to derive the SN security key. The sk-counterSetToAddMod IE may contain a list of SK-Counter IEs. In some embodiments, an SK-Counter IE may take an integer value, and a UE may use the integer value to derive the SN security key.

The sk-counterSetToAddMod IE, in some embodiments, may contain an IE, referred to herein as the “IntraSNCellList IE,” which includes a list of PSCell identities (e.g., a physical cell identity). The UE may consider a CPAC/S-CPAC to be an intra-SN mobility if the identities of the source and the target PSCells are in the IntraSNCellList IE of the same sk-counterSetToAddMod IE. The UE, in these embodiments, may consider a CPAC/S-CPAC to be an inter-SN mobility if the identities of the source and the target PSCells are not in the IntraSNCellList IE of the same sk-counterSetToAddMod IE.

The sk-counterSetToAddMod IE, in some embodiments, may contain a list of physicalCellIdentity IEs. The UE may consider a CPAC/S-CPAC to include an intra-SN mobility if the identities of the source and the target PSCells are in the same sk-counterSetToAddMod IE. The UE, in these embodiments, may consider a CPAC/S-CPAC to be an inter-SN mobility if the identities of the source and the target PSCells are not in the same sk-counterSetToAddMod IE.

The sk-counterSetToAddMod IE, in some embodiments, may contain an IE, referred to herein as the “IntraSNCondReconfigList IE,” which includes a list of conditional reconfiguration IDs (e.g., CondReconfigId). The UE may consider a CPAC/S-CPAC to be an intra-SN mobility if the identity of the selected S-CPAC configuration and the identity of the CPAC/S-CPAC configuration associated with the source PSCell are in the IntraSNCondReconfigList IE of the same sk-counterSetToAddMod IE. The UE, in these embodiments, may consider a CPAC/S-CPAC to be an inter-SN mobility if the identity of the selected S-CPAC configuration and the identity of the CPAC/S-CPAC configuration associated with the source PSCell are not in the IntraSNCondReconfigList IE of the same sk-counterSetToAddMod IE.

The sk-counterSetToAddMod IE, in some embodiments, may contain a list of CondReconfigId IEs. The UE may consider a CPAC/S-CPAC to be an intra-SN mobility if the identity of the selected S-CPAC configuration and the identity of the CPAC/S-CPAC configuration associated with the source PSCell are in the same sk-counterSetToAddMod IE. In these embodiments, the UE may consider a CPAC/S-CPAC to be an inter-SN mobility if the identity of the selected S-CPAC configuration and the identity of the CPAC/S-CPAC configuration associated with the source PSCell are not in the same sk-counterSetToAddMod IE. In some embodiments, a CondReconfigId IE may take a value among the CondReconfigId IEs which the UE is currently configured, and the maximum size of the list may be the number of currently configured conditional configurations.

The sk-counterSetToAddMod IE, in some embodiments, may contain an IE, referred to herein as the “SK-CounterPointer,” which the UE may use to identify and/or indicate the index of the adopted SK-Counter IE in the SK-CounterList IE. The UE may use the SK-CounterPointer IE to indicate the index of the adopted SK-Counter IE to the network (e.g., the source MN and/or the target SN) via RRC signaling. The SK-CounterPointer IE, in some embodiments, may take an integer value from 1 to the number of configured SK-Counter IEs in the sk-counterSetToAddMod IE. The SK-CounterPointer IE, in some embodiments, may take an integer value from 1 to the number of configured SK-Counter IEs in the SK-CounterList IE of the sk-counterSetToAddMod IE.

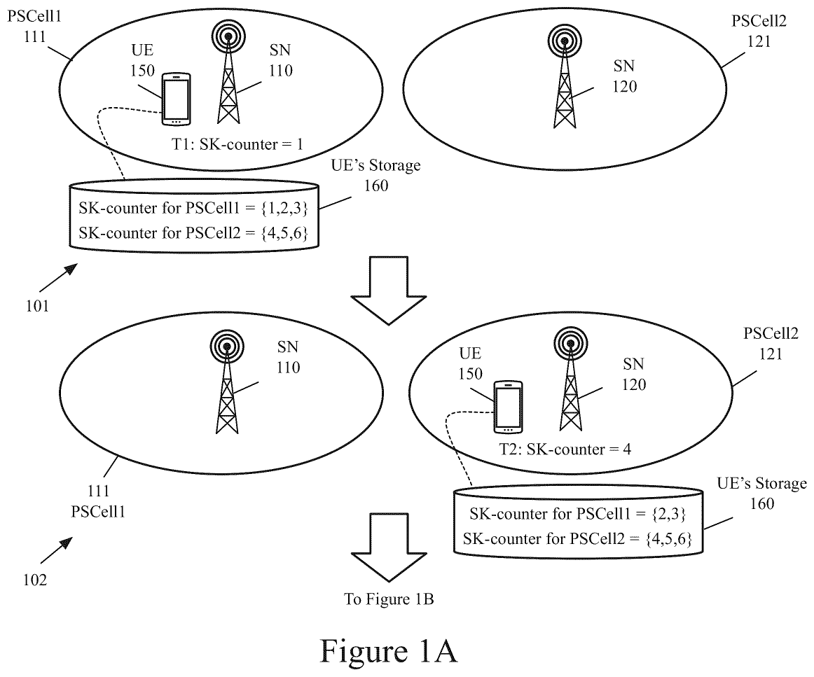

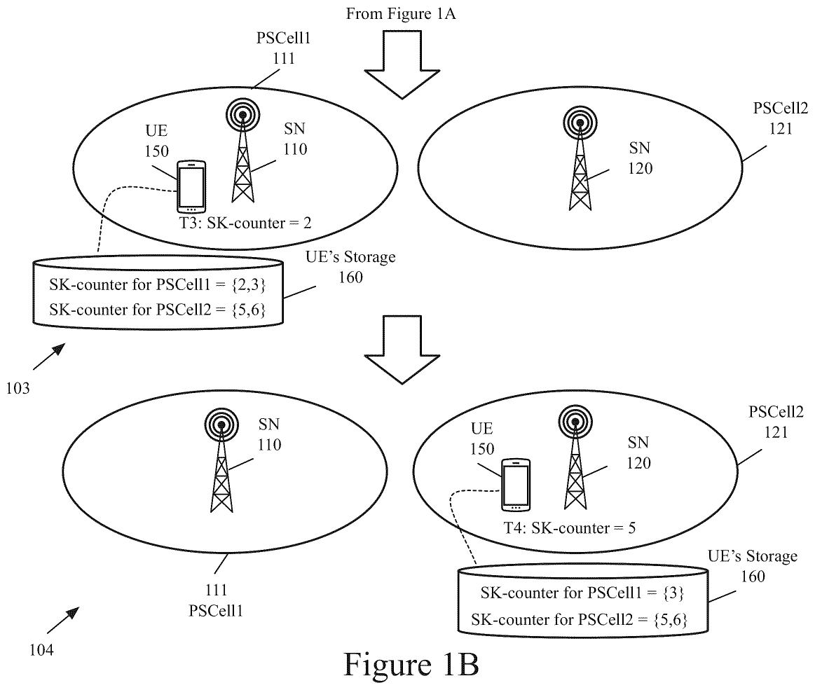

FIGS. 1A and 1B are operational diagrams illustrating an example radio communication system that supports S-CPAC for inter-SN UE mobility events, according to an example implementation of the present disclosure. As shown in FIGS. 1A and 1B, the SN (e.g., a gNB) 110 may configure a logical entity or cell, such as the PSCell 1 111, to serve one or more UEs. The SN (e.g., a gNB) 120 may configure another logical entity or cell, such as the PSCell 2 121, to serve one or more UEs. For clarity, only one UE, one source PSCell, and one target PSCell are shown in FIGS. 1A-1B.

FIGS. 1A and 1B include four operational stages 101-104. In stage 101, the UE 150 may enter the PSCell 1 111, for example, after one or more conditions for a mobility event to move into the PSCell 1 111 are satisfied. As shown by the UE's storage 160, the UE 150 may have received and stored a list of SK-counters for the PSCell 1 111 and a list of SK-counters for the PSCell 2 121. The UE 150, in some embodiments, may receive the SK-counter lists for each PSCell in a separate RRC message from a source cell, such as a PCell of an MN or a PSCell of an SN.

Each SK-counter list may be an ordered list that may include one or more SK-counters. In the example of FIGS. 1A and 1B, each SK-counter list has three entries when the UE 150 enters the PSCell 1 111. Each SK-counter, in some embodiments, may be an integer value.

The UE 150 may be configured with the S-CPAC configuration to switch from another PSCell to the PSCell 1 111 after one or more inter-SN mobility events is/are satisfied. As shown in stage 101, at time T1, the SK-counter value on top of the SK-counter list for the PSCell 1 (in this example, the SK-counter with value of 1) may be applied in configuring the UE with the S-CPAC configuration of the PSCell 1 111. The SK-counter value on the top of the SK-counter list for the PSCell 1 may then be removed from the list. The result is shown in the UE's storage 160 in stage 102, which shows the SK-counter with the value of 1 is removed from the SK-counter list for the PSCell 1 and the next value in the list (e.g., 2) is now the first value of the list.

At the end of stage 101, one or more conditions for an inter-SN UE mobility event may be satisfied before the UE 150 moves into the PSCell 2 121. The UE 150 may be configured with the S-CPAC configuration to switch from the PSCell 1 111 to the PSCell 2 121.

As shown in stage 102, at time T2, the SK-counter value on top of the SK-counter list for the PSCell 2 (in this example, the SK-counter with value of 4) may be applied in configuring the UE with the S-CPAC configuration of the PSCell 2 121. The SK-counter value on the top of the SK-counter list for the PSCell 2 may then be removed from the list. The result is shown in the UE's storage 160 in stage 103, which shows the SK-counter with the value of 4 is removed from the SK-counter list for the PSCell 2 and the next value in the list (e.g., 5) is now the first value of the list.

At the end of stage 102, one or more conditions for an inter-SN UE mobility event mobility event may be satisfied after the UE 150 moves back into the PSCell 1 111. The UE 150 may then be configured with the S-CPAC configuration to switch from the PSCell 2 121 back to the PSCell 1 111.

As shown in stage 103, at time T3, the SK-counter value on top of the SK-counter list for the PSCell 1 (in this example, the SK-counter with value of 2) may be applied in configuring the UE with the S-CPAC configuration of the PSCell 1 111. The SK-counter value on the top of the SK-counter list for the PSCell 1 may then be removed from the list. The result is shown in the UE's storage 160 in stage 104, which shows the SK-counter with the value of 2 is removed from SK-counter list for the PSCell 1.

It should be noted that, although the UE 150 has entered the same PSCell, namely the PSCell 1 111 in both stages 101 and 103, a different SK-counter is applied in configuring the UE with the S-CPAC configuration for each entry. Removing the top entry in the SK-counter when the UE performs the S-CPAC may guarantee that each time the UE moves from one PSCell to another PSCell a new first SK-counter value is used. As an SK-counter is used for deriving a security key for encoding and decoding data, using a different SK-counter for each entry into the same PSCell provides the technical advantage of using a different security key for encoding and decoding data upon each entry to the same PSCell.

At the end of stage 103, one or more conditions for an inter-SN UE mobility event may be satisfied after the UE 150 moves back into the PSCell 2 121. The UE 150 may then be configured with the S-CPAC configuration to switch from the PSCell 1 111 to the PSCell 2 121.

As shown in stage 104, at time T4, the SK-counter value on top of the SK-counter list for the PSCell 2 (in this example, the SK-counter with value of 3) may be applied in configuring the UE with the S-CPAC configuration. The SK-counter value on the top of the SK-counter list for the PSCell 1 may then be removed from the list.

It should also be noted that even though the secondary key for encoding and decoding data is changed in each stage, the remaining configuration of the PSCell remains the same. That is, after removing the SK-counter value on top of the SK-counter list for a PSCell, the UE keeps the reset of the configurations in its storage and reuses them, instead of having to receive a new set of configurations, for example via RRC, each time the UE moves from one PSCell to another.

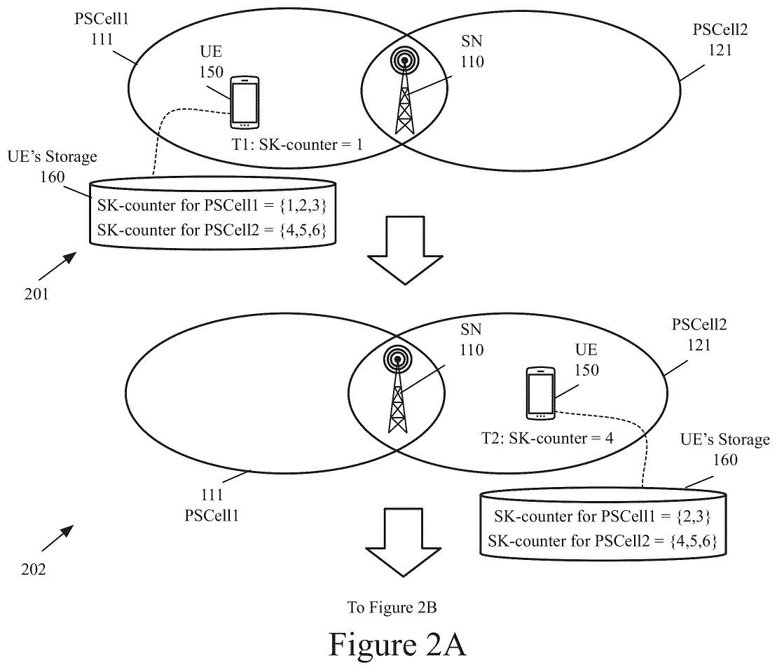

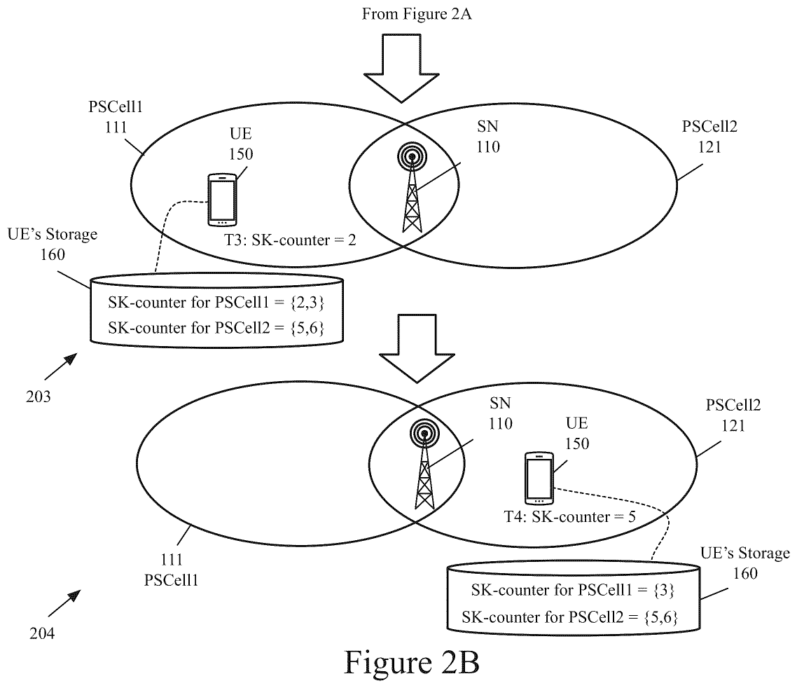

FIGS. 2A and 2B are operational diagram illustrating an example radio communication system that supports S-CPAC for intra-SN UE mobility events, according to an example implementation of the present disclosure. As shown in FIGS. 2A and 2B, the SN (e.g., a gNB) 110 may configure several logical entities, such as the PSCell 1 111 and PSCell 2 121 to serve one or more UEs. For clarity, only one UE 150 is shown in FIGS. 2A and 2B.

FIGS. 2A-2B include four operational stages 201-204. In each of the stages 201-204, the UE 150 may enter one of the PSCells 111 and 121 when one or more intra-SN conditions for entering a PSCell is/are satisfied.

In stage 201, the UE 150 may enter the PSCell 1 111, for example, after one or more conditions for a mobility event to move into the PSCell 1 111 are satisfied. As shown by the UE's storage 160, the UE 150 may have received and stored a list of SK-counters for the PSCell 1 111 and a list of SK-counters for the PSCell 2 121. The UE 150, in some embodiments, may receive the SK-counter lists for each PSCell in a separate RRC message from a source cell, such as a PCell of an MN or a PSCell of an SN.

Each SK-counter list may be an ordered list that may include one or more SK-counters. In the example of FIGS. 2A and 2B, each SK-counter list has three entries when the UE 150 enters the PSCell 1 111. Each SK-counter, in some embodiments, may be an integer value.

The UE 150 may be configured with the S-CPAC configuration to switch from another PSCell to the PSCell 1 111 after one or more inter-SN mobility events is/are satisfied. As shown in stage 201, at time T1, the SK-counter value on top of the SK-counter list for the PSCell 1 (in this example, the SK-counter with value of 1) may be applied in configuring the UE with the S-CPAC configuration of the PSCell 1 111. The SK-counter value on the top of the SK-counter list for the PSCell 1 may then be removed from the list. The result is shown in the UE's storage 160 in stage 202, which shows the SK-counter with the value of 1 is removed from the SK-counter list for the PSCell 1 and the next value in the list (e.g., 2) is now the first value of the list.

At the end of stage 201, one or more conditions for an inter-SN UE mobility event may be satisfied before the UE 150 moves into the PSCell 2 121. The UE 150 may be configured with the S-CPAC configuration to switch from the PSCell 1 111 to the PSCell 2 121.

As shown in stage 202, at time T2, the SK-counter value on top of the SK-counter list for the PSCell 2 (in this example, the SK-counter with value of 4) may be applied in configuring the UE with the S-CPAC configuration of the PSCell 2 121. The SK-counter value on the top of the SK-counter list for the PSCell 2 may then be removed from the list. The result is shown in the UE's storage 160 in stage 203, which shows the SK-counter with the value of 4 is removed from the SK-counter list for the PSCell 2 and the next value in the list (e.g., 5) is now the first value of the list.

At the end of stage 202, one or more conditions for an inter-SN UE mobility event mobility event may be satisfied after the UE 150 moves back into the PSCell 1 111. The UE 150 may then be configured with the S-CPAC configuration to switch from the PSCell 2 121 back to the PSCell 1 111.

As shown in stage 203, at time T3, the SK-counter value on top of the SK-counter list for the PSCell 1 (in this example, the SK-counter with value of 2) may be applied in configuring the UE with the S-CPAC configuration of the PSCell 1 111. The SK-counter value on the top of the SK-counter list for the PSCell 1 may then be removed from the list. The result is shown in the UE's storage 160 in stage 204, which shows the SK-counter with the value of 2 is removed from SK-counter list for the PSCell 1.

It should be noted that, although the UE 150 has entered the same PSCell, namely the PSCell 1 111 in both stages 201 and 203, a different SK-counter is applied in configuring the UE with the S-CPAC configuration for each entry. Removing the top entry in the SK-counter when the UE performs the S-CPAC may guarantee that each time the UE moves from one PSCell to another PSCell a new first SK-counter value is used. As an SK-counter is used for deriving a security key for encoding and decoding data, using a different SK-counter for each entry into the same PSCell provides the technical advantage of using a different security key for encoding and decoding data upon each entry to the same PSCell.

At the end of stage 203, one or more conditions for an inter-SN UE mobility event may be satisfied after the UE 150 moves back into the PSCell 2 121. The UE 150 may then be configured with the S-CPAC configuration to switch from the PSCell 1 111 to the PSCell 2 121.

As shown in stage 204, at time T4, the SK-counter value on top of the SK-counter list for the PSCell 2 (in this example, the SK-counter with value of 3) may be applied in configuring the UE with the S-CPAC configuration. The SK-counter value on the top of the SK-counter list for the PSCell 1 may then be removed from the list.

It should also be noted that even though the secondary key for encoding and decoding data is changed in each stage, the remaining configuration parameters of the PSCell remains the same. That is, after removing the SK-counter value on top of the SK-counter list for a PSCell, the UE keeps the reset of the configurations in its storage and reuses them, instead of having to receive a new set of configurations, for example via RRC, each time the UE moves from one PSCell to another.

The following is an example of the structure of the sk-counterSetToAddMod IE:

```
sk-counterSetToAddModList::=SEQUENCE (size(1..maxNrofSN)) OF sh-counterSetToAddMod
sk-counterSetToAddMod::=Sequence{
  sk-counterSetId SK-CounterSetId,
  sk-counterList SK-CounterList,
  intraSNCellList SEQUENCE(size(1..maxNrofCondCells)) OF physicalCellId,
  sk-counterPointer SK-CounterPointer
}
SK-CounterList::=SEQUENCE (size(1..maxNrofSKCounterPerSN)) OF SK-Counter
```

According to the above example structure, the SK-CounterSetId IE may indicate the identity of the association between a list of SK-Counter IEs and a list of physicalCellId IEs, and the SK-CounterSetId IE may take an integer value from 1 to the number of the configured lists of SK-Counter IEs. The SK-CounterList IE may indicate the list of SK-Counter IEs which the UE may apply upon an inter-SN CPC. The SK-CounterPointer IE may indicate the index of the SK-Counter IE which the UE selects for the new SN, and the SK-CounterPointer IE may take an integer value from 1 to the number of the configured SK-Counter IEs in the SK-CounterList IE.

In some embodiments, upon receiving the sk-counterSetToAddMod IE from the source node (e.g., the source MN or SN), the UE may store the sk-counterSetToAddMod IE.

In some embodiments, the source node (e.g., the source MN/SN) may send to the UE an IE (e.g., the condReconfigToRemoveList), for example, via RRC signaling, to indicate the release of some S-CPAC configurations. In some embodiments, upon receiving the IE, the UE may release the indicated stored S-CPAC configurations. In some embodiments, upon releasing the S-CPAC configurations, the UE may check and modify the sk-counterSetToAddMod IE.

The UE, in some embodiments, may remove from the intraSNCellList IE the cell IDs (e.g., the physicalCellId) which correspond to the S-CPAC configurations indicated to be released. The UE may remove from the intraSNCondReconfigList IE the configuration IDs (e.g., the condReconfigId) which correspond to the S-CPAC configurations indicated to be released.

In some embodiments, after removing the entries from the intraSNCellList, if the intraSNCellList does not contain any cell ID (e.g., the physicalCellId), the UE may remove the sk-counterSetToAddMod which corresponds to the empty intraSNCellList. In some embodiments, after removing the entries from the intraSNCondReconfigList IE, if the intraSNCondReconfigList does not contain any configuration IDs (e.g., the condReconfigId), the UE may remove the sk-counterSetToAddMod which corresponds to the empty intraSNCondReconfigList.

In some embodiments, the source node (source MN/SN) may send to the UE an IE, referred to herein as the “sk-counterSetToRemoveList IE,” for example, via RRC signaling, to indicate the release of some S-CPAC configurations. The sk-counterSetToRemoveList may include a list of SK-CounterSetId IEs. Upon receiving the sk-counterSetToRemoveList IE, the UE may release the stored sk-counterSetToAddMod whose SK-CounterSetId IEs are in the sk-counterSetToRemoveList. For example, if an SK-CounterSetId with value 2 and an SK-CounterSetId with value 3 are present, the UE may release the sk-counterSetToAddMod with SK-CounterSetId=2 and the sk-counterSetToAddMod with SK-CounterSetId=3.

The node (e.g., the source MN/SN), in some embodiments, may send to the UE an IE, referred to herein as the “sk-counterSetToAddModList IE,” which includes a list of sk-counterSetToAddMod IEs to indicate additions or modifications on sk-counterSetToAddMod IEs. The sk-counterSetToAddModList may include a list of sk-counterSetToAddMod IEs. In some embodiments, upon receiving the sk-counterSetToAddModList, the UE may check the SK-CounterSetId in both the sk-counterSetToAddModList IE and in the stored sk-counterSetToAddMod IEs. The UE may release the stored sk-counterSetToAddMod IEs whose SK-CounterSetId are in the sk-counterSetToAddModList, and the UE may store the sk-counterSetToAddMod IEs received in the sk-counterSetToAddModList.

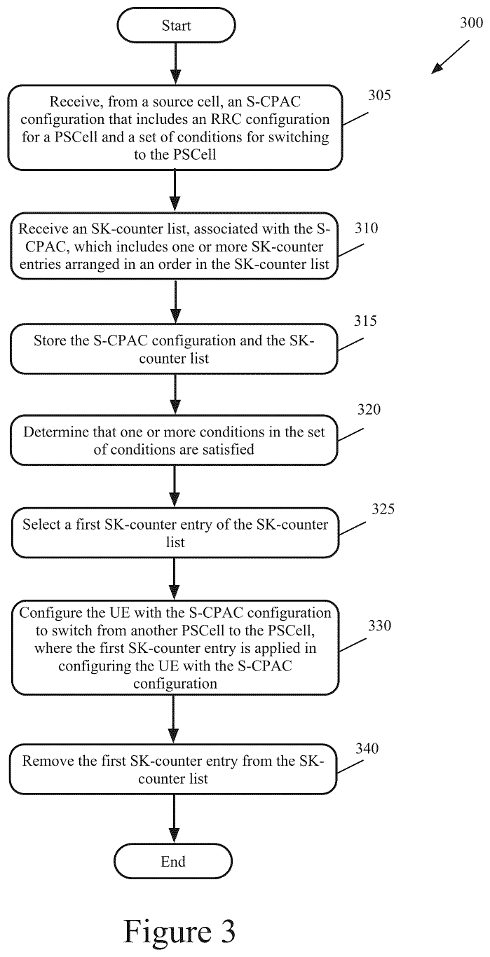

FIG. 3 is a flowchart illustrating an example method/process 300 performed by a UE for configuring an S-CPAC to the UE, according to an example implementation of the present disclosure. With reference to FIG. 3, the process 300 may be performed by at least one processor of a UE, such as the UE 150, shown in FIGS. 1A-1B and 2A-2B.

The process 300 may receive (at block 305), from a source cell, an S-CPAC configuration that includes an RRC configuration for a PSCell and a set of conditions for switching to the PSCell. The UE 150 of may receive the S-CPAC configuration from a source such as a PCell of an MN or a PSCell of an SN.

For example, as described above, the S-CPAC configuration may include a conditional configuration ID (e.g., condReconfigId), one or more execution conditions (e.g., measId), an RRC configuration (e.g., RRCReconfiguration) to be applied when the execution condition(s) are satisfied, and a list of execution conditions (e.g., meadId) to be applied to substitute execution condition(s) in other S-CPAC configurations when the execution condition(s) included in the S-CPAC configuration are satisfied.

The process 300 may receive (at block 310) an SK-counter list associated with the S-CPAC. The SK-counter list may include one or more SK-counter entries arranged in an order in the SK-counter list. In some embodiments, the process 300 may receive an IE that includes the SK-counter list and an identifier (ID) that identifies the SK-counter list. For example, as described above, the UE may be configured with the “sk-counterSetToAddMod IE. The sk-counterSetToAddMod IE may contain the “SK-CounterSetID IE,” which the UE may use to identify the corresponding sk-counterSetToAddMod IE. The SK-CounterSetID IE, in some embodiments, may take integer values from 1 to the number of configured sk-counterSetToAddMod IEs.

The process 300, in some embodiments, may receive the S-CPAC configuration and the IE in the same RRC message. In other embodiments, the process 300 may receive the S-CPAC configuration and the IE in separate RRC messages.

The process 300 may store (at block 315) the S-CPAC configuration and the SK-counter list. For example, the process 300 may store the S-CPAC configuration and the SK-counter list in the storage 160 of the UE 150 shown in FIGS. 1A-1B and 2A-2B.

The process 300 may determine (at block 320) that one or more conditions in the set of conditions are satisfied. The process 300 may then select (at block 325) a first SK-counter entry of the SK-counter list. For example, the process 300 may select the top SK-counter entry from the corresponding SK-counter list, as described above with reference to FIGS. 1A-1B and 2A-2B. As described below in the “SK-counter List Maintenance” section, if the sk-counterPointer is not configured, and if the UE does not maintain varUsedSKCounterList, the UE may select the SK-counter value which is the first entry in the SK-CounterList.

The process 300 may configure (at block 330) the UE with the S-CPAC configuration to switch from another PSCell to the PSCell. The first SK-counter entry from the SK-counter list may be applied in configuring the UE with the S-CPAC configuration. Applying the first SK-counter entry in configuring the UE with the S-CPAC configuration, in some embodiments, may include deriving an SK based on a value of the first SK-counter entry. The UE may encode data transmitted to the PSCell and decode data received from the PSCell using the SK. For example, as described above, the UE may derive the SN security key from an SN counter (e.g., a configured SK-counter), whose value may be configured in the CPA and/or CPC configuration.

The process 300 may remove (at block 340) the first SK-counter entry from the SK-counter list. For example, the process 300 may remove the first SK-counter entry from the SK-counter list, as described above with reference to FIGS. 1A-1B and 2A-2B. As described above, if the sk-counterPointer is not configured, and if the UE does not maintain varUsedSKCounterList, after transmitting the RRCReconfigurationComplete message to the source MN, the UE may remove the selected SK-Counter value from the stored SK-CounterList in the sk-counterSetToAddMod (or in the SK-CounterConfig). The process 300 may then end.

The S-CPAC configuration may be a first S-CPAC configuration and the set of conditions may be a first set of conditions. In some embodiments, the process 300 may receive a second S-CPAC configuration from the source cell. The second S-CPAC configuration may include another RRC configuration for a second PSCell, which may belong to a different SN, and a second set of conditions for switching to the second PSCell.

The process 300 may receive a second SK-counter list associated with the second S-CPAC. The second SK-counter list may include one or more SK-counter entries arranged in the order in the second SK-counter list. The process 300 may store the second S-CPAC configuration and the second SK-counter list. The process 300 may determine that at least one condition in the second set of conditions is satisfied. The process 300 may then select a first SK-counter entry of the second SK-counter list and may configure the UE with the second S-CPAC configuration to switch from the first PSCell to the second PSCell. The first SK-counter entry of the second SK-counter list may be applied in configuring the UE with the second S-CPAC configuration. The process 300 may remove the first SK-counter entry of the second SK-counter list from the second SK-counter list.

The process 300, in some embodiments, may determine that one or more conditions in the first set of conditions are satisfied. The process 300 may select a second SK-counter entry of the first SK-counter list, where the second SK-counter entry is the next entry, in the order, after the removed first SK-counter entry in the first SK-counter list. The process 300 may switch from the second PSCell back to the first PSCell. The UE may apply the second SK-counter entry of the first SK-counter list when the UE is configured back based on the first S-CPAC configuration. The process 300 may remove the second SK-counter entry of the first SK-counter list from the first SK-counter list.

### Sk-Counter List Configuration Method 2—Intra-Sn Cell List Contained in the Sk-Counter List

The source node (e.g., the source MN/SN), in some embodiments, may include the IE, referred to herein as the “SK-CounterConfig IE,” associated with the SK-counter in the RRCReconfiguration IE in each S-CPAC configuration, and the source node may transmit the S-CPAC configurations to the UE via RRC messages.

The SK-CounterConfig IE, in some embodiments, may contain an IE (e.g., the SK-CounterList IE) that may include a list of SK-Counter IEs. In some embodiments, the size of the SK-CounterList IE may be the number of SK-counter values which are configured for the associated SN, for the associated PSCell, or for the corresponding S-CPAC configuration. In some embodiments, an SK-Counter IE may take an integer value.

The SK-CounterConfig IE, in some embodiments, may contain a list of SK-Counter IEs. In some embodiments, an SK-Counter IE may take an integer value.

The SK-CounterConfig IE, in some embodiments, may contain an IE, referred to herein as the “IntraSNCellId IE,” which may include a list of PSCell identities (e.g., physical cell identity). In some embodiments, the IntraSNCellId IE may not contain the cell ID of the PSCell corresponding to the S-CPAC configuration of the SK-CounterConfig. The UE may consider a CPAC/S-CPAC to be an intra-SN mobility if the identity of the target PSCell is in the IntraSNCellId IE of the SK-CounterConfig IE.

The SK-CounterConfig IE, in some embodiments, may contain a list of physicalCellId IE. The UE may consider a CPAC/S-CPAC to be an intra-SN mobility if the identity of the target PSCell is in the list.

The SK-CounterConfig, in some embodiments, may contain an IE, referred to herein as the “IntraSNCondId IE,” which includes a list of conditional configuration IDs. The UE may consider a CPAC/S-CPAC to be an intra-SN mobility if the conditional configuration ID corresponding to the source PSCell is in the IntraSNCondId IE of the SK-CounterConfig IE. In some embodiments, the size of the IntraSNCondId IE may be the number of configured candidate PSCells which belong to the same SN as the candidate PSCell corresponding to the conditional configuration of the SK-CounterConfig IE.

The SK-CounterConfig, in some embodiments, may contain a list of conditional configuration ID IEs. The UE may consider a CPAC/S-CPAC to be an intra-SN mobility if the conditional configuration ID corresponding to the source PSCell is in the list of conditional configuration ID IEs. In some embodiments, a conditional configuration ID IE may take an integer value from 1 to the number of configured conditional configurations.

The SK-CounterConfig, in some embodiments, may contain an IE (e.g., the SK-CounterPointer IE), which the UE may use to identify and/or indicate the index of the adopted SK-Counter IE in the SK-CounterList IE. The UE may use the SK-CounterPointer IE to indicate the index of the adopted SK-Counter IE to the network (e.g., the source MN and/or the target SN) via RRC signaling. In some embodiments, the SK-CounterPointer IE may take an integer value from 1 to the number of the configured SK-Counter IEs in the SK-CounterConfig IE. In some embodiments, the SK-CounterPointer IE may take an integer value from 1 to the number of the configured SK-Counter IEs in the SK-CounterList IE of the SK-CounterConfig IE.

The following is an example of the structure of the sk-counterSetToAddMod IE:

```
CondReconfigToAddMod::=SEQUENCE{
  condReconfigId CondReconfigId,
  condExecutionCond SEQUENCE(size(1..2)) OF measId,
  condRRCConfigOCTET STRING(CONTAINING RRCReconfiguration)
}
RRCReconfiguration::=SEQUENCE{
  ...
  sk-counterConfig SK-CounterConfig,
  ...
}
SK-CounterConfig::=SEQUENCE{
  sk-counterList SK-CounterList,
  intraSNCellId SEQUENCE(size(1..maxNrofCondCells))OF physicalCellId,
  sk-counter Pointer sk-counterPointer
}
SK-CounterList::=SEQUENCE(size(1..maxNrofSKCounterPerSN)) OF SK-Counter
```

According to the above example structure, the SK-CounterConfig IE may contain an SK-CounterList IE, a list of physicalCellId IEs, and an sk-counterPointer IE. The SK-CounterList IE may indicate the list of SK-Counter IEs which the UE may apply upon an inter-SN CPC. Each SK-Counter IE may take an integer value. The sk-counterPointer IE may indicate the index of the SK-Counter IE which the UE selects for the new SN, and the sk-counterPointer IE may take an integer value from 1 to the number of the configured SK-Counter IEs in the SK-CounterList IE.

In some embodiments, upon receiving the S-CPAC configurations containing the SK-CounterConfig IE from the source node (e.g., the source MN/SN), the UE may store the received S-CPAC configurations.

The source node (e.g., the source MN/SN), in some embodiments, may send to the UE an IE (e.g., the condReconfigToRemoveList) via RRC signaling to indicate the release of some S-CPAC configurations.

In some embodiments, upon receiving the IE which includes a list of conditional configuration IDs (e.g., the condReconfigId), for each stored S-CPAC configuration, the UE may check whether the conditional configuration ID of the S-CPAC configuration is in the list in the received IE.

In some embodiments, upon receiving the IE (e.g., the condReconfigToRemoveList) which includes a list of conditional configuration IDs (e.g., the condReconfigId), if a stored S-CPAC configuration whose conditional configuration ID is in the list in the received IE (e.g., the condReconfigToRemoveList), the UE may release the S-CPAC configuration.

In some embodiments, upon receiving the IE (e.g., the condReconfigToRemoveList) which includes a list of conditional configuration IDs (e.g. the condReconfigId), if a stored S-CPAC configuration whose conditional configuration ID is not in the list in the received IE (e.g., the condReconfigToRemoveList), the UE may remove the cell IDs (e.g., the physicalCellId) which correspond to the conditional configuration IDs in the received IE and which are present in the intraSNCellId of the S-CPAC configuration, from the intraSNCellId in the SK-CounterConfig of the S-CPAC configuration. In some embodiments, after modifying the S-CPAC configuration, the UE may store the modified S-CPAC configuration.

In some embodiments, upon receiving the IE (e.g., the condReconfigToRemoveList) which includes a list of conditional configuration IDs (e.g., the condReconfigId), if a stored S-CPAC configuration whose conditional configuration ID is not in the list in the received IE (e.g., the condReconfigToRemoveList), the UE may remove the conditional configuration IDs (e.g., the condReconfigId) which are in the list in the received IE and which are present in the intraSNCondReconfigId of the S-CPAC configuration, from the intraSNCondReconfigId in the SK-CounterConfig of the S-CPAC configuration. After modifying the S-CPAC configuration, the UE may store the modified S-CPAC configuration.

### Sk-Counter List Maintenance

In some embodiments, when one or multiple S-CPAC configurations are considered to be satisfied with their corresponding execution conditions, the UE may select a satisfied S-CPAC configuration and may execute the selected S-CPAC configuration. Upon the execution of the selected S-CPAC configuration, the UE may apply the RRC reconfiguration IE included in the S-CPAC configuration.

In some embodiments, upon applying the RRC reconfiguration, a UE may identify an intra-SN mobility if the cell IDs (e.g., the physicalCellId) of the source and the target PSCells are in the same intraSNCellList of the same sk-counterSetToAddMod. Upon applying the RRC reconfiguration, a UE may identify an intra-SN mobility if the cell ID (e.g., the physicalCellId) of the source PSCell is in the intraSNCellId of the SK-CounterConfig in the applied RRC reconfiguration.

In some embodiments, upon applying the RRC reconfiguration, a UE may identify an inter-SN mobility if the cell IDs (e.g., the physicalCellId) of the source and the target PSCells are not in the same intraSNCellList of the same sk-counterSetToAddMod. Upon applying the RRC reconfiguration, a UE may identify an inter-SN mobility if the cell ID (e.g., the physicalCellId) of the source PSCell is not in the intraSNCellId of the SK-CounterConfig in the applied RRC reconfiguration.

In some embodiments, upon applying the RRC reconfiguration, a UE may identify an intra-SN mobility if the conditional configuration IDs (e.g., the condReconfigId) corresponding to the source and the target PSCells are in the same intraSNCondReconfigId of the same sk-counterSetToAddMod. Upon applying the RRC reconfiguration, the UE may identify an intra-SN mobility if the conditional configuration ID (e.g., the condReconfigId) corresponding to the source PSCell is in the intraSNCondReconfigId of the SK-CounterConfig in the applied RRC reconfiguration.

In some embodiments, upon applying the RRC reconfiguration, a UE may identify an inter-SN mobility if the conditional configuration IDs (e.g., the condReconfigId) corresponding to the source and the target PSCells are not in the same intraSNCondReconfigId of the same sk-counterSetToAddMod. Upon applying the RRC reconfiguration, the UE may identify an inter-SN mobility if the conditional configuration ID (e.g., the condReconfigId) corresponding to the source PSCell is not in the intraSNCondReconfigId of the SK-CounterConfig in the applied RRC reconfiguration.

In some embodiments, upon applying the RRC reconfiguration, if the UE identifies an intra-SN mobility, the UE may use the SK-Counter value which was used for the connection to the source SN. In some embodiments, upon applying the RRC reconfiguration, if the UE identifies an inter-SN mobility, and if the sk-counterPointer is not configured, the UE may select an SK-Counter value from the configured SK-CounterList in the sk-counterSetToAddMod (or in the SK-CounterConfig) and apply the selected SK-Counter value.

The UE, in some embodiments, may maintain a variable recording the SK-Counter values, which have been used for the target SN. These variables are referred to, herein, as the “varUsedSKCounterList.” If the sk-counterPointer is not configured, and if the UE maintains the varUsedSKCounterList, the UE may select the SK-counter randomly from the configured values, which are in the SK-CounterList and not in the varUsedSKCounterList. In some embodiments, if the sk-counterPointer is not configured, and if the UE does not maintain varUsedSKCounterList, the UE may select the SK-Counter value randomly from the configured values which are in the SK-CounterList.

In some embodiments, if the sk-counterPointer is not configured, and if the UE does not maintain the varUsedSKCounterList, the UE may select the SK-counter value which is the first entry in the SK-CounterList. In some embodiments, the entries in the SK-CounterList may range from the smallest one to the largest one. In some embodiments, the entries in the SK-CounterList may range from the largest one to the smallest one. In some embodiments, the UE may select the smallest one in the SK-CounterList. In some embodiments, the UE may select the largest one in the SK-CounterList.

In some embodiments, if the sk-counterPointer is not configured, the UE may select the SK-counter in the next entry of the SK-CounterList. If the sk-counterPointer is not configured, after selecting the SK-counter value, the UE may include the selected SK-counter value in the RRCReconfigurationComplete message and transmit the RRCReconfigurationComplete message to the source MN.

In some embodiments, if the sk-counterPointer is not configured, and if the UE maintains varUsedSKCounterList, after transmitting the RRCReconfigurationComplete message to the source MN, the UE may add the selected SK-Counter value as an entry into the stored varUsedSKCounterList. If the sk-counterPointer is not configured, and if the UE does not maintain the varUsedSKCounterList, after transmitting the RRCReconfigurationComplete message to the source MN, the UE may remove the selected SK-counter value from the stored SK-CounterList in the sk-counterSetToAddMod (or in the SK-CounterConfig).

In some embodiments, if the UE identifies an inter-SN mobility, and if the sk-counterPointer is configured, the UE may select an sk-counterPointer value from 1 to the number of the configured SK-Counter IEs. The value of sk-counterPointer, in some embodiments, is one-to-one mapped to the SK-Counter value, and the mapping relation may be identified by both the UE and the source node (e.g., the source MN/SN). For example, sk-counterPointer=1 may imply that the selected SK-counter value is the first entry in the configured SK-CounterList, and sk-counterPointer=2 may imply that the selected SK-counter value is the second entry in the configured SK-counter value, and so on. In some embodiments, after determining the sk-counterPointer, the UE may apply the SK-counter value which corresponds to the sk-counterPointer.

A UE, in some embodiments, may maintain a variable, referred to herein as the “varUsedSKCounterPointerList,” which records the sk-counterPointer values which have been used for the target SN. If the sk-counterPointer is configured, and if the UE maintains the varUsedSKCounterPointerList, the UE may select the value of the sk-counterPointer randomly from the values which are not in the varUsedSKCounterPointerList. In some embodiments, if the sk-counterPointer is configured, the UE may apply the stored sk-counterPointer value.

In some embodiments, if the sk-counterPointer is configured, after determining the sk-counterPointer and applying the corresponding SK-counter value, the UE may include the value of sk-counterPointer in the RRCReconfigurationComplete message and may transmit the RRCReconfigurationComplete message to the source MN.

In some embodiments, if the sk-counterPointer is configured, after transmitting the RRCReconfigurationComplete message to the MN, the UE may increase the value of the stored sk-counterPointer in the sk-counterToAddMod associated with the new SN by 1. In some embodiments, if the sk-counterPointer is configured, after transmitting the RRCReconfigurationComplete message to the MN, the UE may increase the value of the stored sk-counterPointer in each of the SK-CounterConfig IEs which are associated with the new SN by 1. In some embodiments, if the sk-counterPointer is configured, and if the UE maintains the varUsedSKCounterPointerList, the UE may add the selected value of the sk-counterPointer to the stored varUsedSKCounterPointerList.

Upon receiving the RRCReconfigurationComplete message from the UE, the source MN, in some embodiments, may identify the selected PSCell and its corresponding SN according to the information in the RRCReconfigurationComplete message. The source MN, in some embodiments, may identify an intra-SN mobility if the selected PSCell and the source PSCell are associated with the same SN.

The source MN, in some embodiments, may identify an inter-SN mobility if the selected PSCell and the source PSCell are not associated with the same SN. If the source MN identifies an inter-SN mobility, the source MN may forward to the new SN the IEs related to the new SN via XnAP signaling/inter-node RRC signaling.

In some embodiments, if the source MN identifies an inter-SN mobility, the source MN may send to the source SN an XnAP message/inter-node RRC message containing an indication that the UE has performed an inter-SN mobility. Upon receiving the XnAP message/inter-node RRC message from the source MN, the source SN may remove from the stored SK-CounterList the SK-counter value which was used when the UE was connected to the source SN.

In some embodiments, if the received information includes an SK-counter value, the SN may assume that the UE applies the received SK-counter value, and the SN may apply the received SK-counter value. In some embodiments, if the received information includes an sk-counterPointer, the SN may apply the SK-counter value which is mapped to the received value of sk-counterPointer. In some embodiments, if the received information includes neither an SK-counter value nor an sk-counterPointer, the SN may apply the SK-counter value which corresponds to the first entry in the SK-CounterList stored in the SN.

No Available Sk-Counter after S-CPAC

In some embodiments, upon an inter-SN S-CPAC execution, if there is exactly one SK-counter value which may be used in the target SN (e.g., there is exactly one unused SK-counter value for the target SN), the UE may include an indication that there is no available SK-counter value for the SN in the RRCReconfigurationComplete message. The UE, in some embodiments, may also include the new PSCell ID (e.g., the physicalCellId), and/or the ID of the executed conditional configuration (e.g., the condReconfigId), and/or the SK-CounterSetId associated with the new PSCell in the RRCReconfigurationComplete message. Upon receiving the RRCReconfigurationComplete message containing the indication that there is no available SK-counter value for the SN, the source node (e.g., the source MN/SN) may transmit to the UE an RRC message including a new SK-CounterList IE for the new SN. Upon receiving the RRC message containing a new SK-CounterList IE for the new SN, the UE may release the stored SK-CounterList IE associated with the new SN and store the received SK-CounterList IE. In some embodiments, upon storing the received SK-CounterList IE, if the sk-counterPointer is configured, the UE may reset the value of sk-counterPointer to 1.

After the execution of an inter-SN S-CPAC, if all the SK-counter values for the SN have been used (including the SK-counter value used for the current connection), the UE, in some embodiments, may keep all S-CPAC configurations which are associated with the SN, and the UE may keep evaluating all S-CPAC configurations which are associated with the SN. After the execution of an inter-SN S-CPAC, if all the SK-counter values for the former (source) SN have been used (including the SK-counter value used for the previous connection), the UE may release all the S-CPAC configurations which are associated with the former (source) SN, and the UE may keep evaluating all the S-CPAC configurations which are not associated with the former (source) SN.

In some embodiments, before, or upon, releasing the S-CPAC configurations which are associated with the former (source SN), the UE may include an indication that the UE releases the S-CPAC configurations in an RRC message and may send the RRC message to the source node (e.g., the source MN).

The UE, in some embodiments, may also include the ID of the former (source) PSCell (e.g., the physicalCellId) in the RRC message. The UE may also include the ID of the conditional reconfiguration (e.g., the condReconfigId) associated with the former (source) PSCell in the RRC message. The UE may also include the SK-CounterSetId corresponding to the former (source) PSCell in the RRC message.

In some embodiments, after the execution of an inter-SN S-CPAC, if all SK-counter values for the former (source) SN have been used (including the SK-counter values used for the previous connection), the UE may keep all the S-CPAC configurations, and the UE may suspend the evaluation of all the S-CPAC configurations which are associated with the former (source) SN, and the UE may keep evaluating all the S-CPAC configurations which are not associated with the former (source) SN. The UE may include an indication that there is no available SK-counter value for the former (source) SN in the RRCReconfigurationComplete message. The UE may also include the former (source) PSCell ID (e.g., the physicalCellId), and/or the ID of the conditional configuration (e.g., the condReconfigId) associated with the former (source) PSCell, and/or the SK-CounterSetId associated with the former (source) PSCell in the RRCReconfigurationComplete message.

In some embodiments, upon receiving the RRCReconfigurationComplete message containing the indication that there is no available SK-counter value for the former (source) SN, the source node (e.g., the source MN/SN) may transmit to the UE an RRC message including a new SK-CounterList IE for the new SN. Upon receiving the RRC message containing a new SK-CounterList IE for the new SN, the UE may release the stored SK-CounterList IE associated with the new SN and store the received SK-CounterList IE. Upon storing the received SK-CounterList IE, if the sk-counterPointer is configured, the UE may reset the value of sk-counterPointer to 1.

In some embodiments, upon receiving the RRCReconfigurationComplete message containing the indication that there is no available SK-counter value for the former (source) SN, the source node (e.g., the source MN/SN) may transmit to the UE an RRC message including an indication to release the S-CPAC configurations associated with the former (source) SN. Upon receiving the RRC message containing an indication to release the S-CPAC configurations associated with the former (source) SN, the UE may release the stored S-CPAC configurations associated with the former (source) SN, and the UE may release the SK-CounterToAddMod entry which is associated with the former (source) SN.

In some embodiments, upon an inter-SN CPAC execution, if the new SN identifies that there is no unused SK-Counter, the new SN may generate a new SK-CounterList, may include the new SK-CounterList in an SN RRCReconfiguration message, and may transmit the SN RRCReconfiguration message to the UE. Upon receiving the SN RRCReconfiguration message containing a new SK-CounterList, the UE may release the stored SK-CounterList in the SK-CounterToAddMod entry associated with the new SN and store the received SK-CounterList.

The new SN, in some embodiments, may also include the SK-CounterSetId corresponding to the new SN, and/or the conditional configuration ID (e.g., the condReconfigId) of the executed S-CPAC configuration, and/or the new PSCell ID (e.g., the physicalCellId) into the SN RRCReconfiguration message. The new SN, in some embodiments, may transmit the SN RRCReconfiguration to the UE via the signaling radio bearer 3 (SRB3). The new SN, in other embodiments, may transmit the SN RRCReconfiguration to the UE via source MN via signaling radio bearer 3 (SRB1).

### No Available Sk-Counter Upon S-CPAC

In some embodiments, upon an inter-SN S-CPAC execution, if there is no SK-counter value which may be used in the target SN (i.e., there is no unused SK-counter value for the SN), the UE may continue using the configuration which is used in the source SN before the S-CPAC execution. Upon an inter-SN S-CPAC execution, if there is no SK-counter value which may be used in the target SN (i.e., there is no unused SK-counter value for the SN), the UE may continue using the configuration in the selected S-CPAC configuration and deactivate the SCG.

In some embodiments, upon an inter-SN S-CPAC execution, if there is no SK-counter value which may be used in the target SN (i.e., there is no unused SK-Counter value for the SN), the UE may release the S-CPAC configurations which are associated with the SN which is out of SK-counter values, and the UE may keep the S-CPAC configurations which are not associated with the SN which is out of SK-counter values. Upon an inter-SN S-CPAC execution, if there is no SK-counter value which may be used in the target SN (e.g., there is no unused SK-counter value for the SN), the UE may keep all the S-CPAC configurations.

In some embodiments, upon an inter-SN S-CPAC execution, if there is no SK-Counter value which may be used in the target SN (e.g., there is no unused SK-Counter value for the SN), the UE may stop all the evaluations on the S-CPAC configurations. Upon an inter-SN S-CPAC execution, if there is no SK-Counter value which may be used in the target SN (e.g., there is no unused SK-Counter value for the SN), the UE may stop evaluating the execution conditions for the S-CPAC configurations which are associated with the SN which is out of SK-Counter values, and the UE may keep evaluating the execution conditions for the S-CPAC configurations which are not associated with the SN which is out of SK-Counter values.

In some embodiments, upon an inter-SN S-CPAC execution, if there is no SK-counter value which may be used in the target SN (i.e., there is no unused SK-counter value for the SN), the UE may initiate the SCG failure information procedure to report SCG reconfiguration error. Upon initiating of the SCG failure information procedure, the UE may suspend the SCG transmission for all SRBs and DRBs, and/or the UE may reset the SCG MAC entity. The UE may transmit an RRC message (e.g., SCGFailureInformation) to the source MN.

The UE, in some embodiments, may set an indication that the failure is due to no available SK-counter value (e.g., set the failureType to ‘NoAvailableSKCounter’) and may include the indication into the SCGFailureInformation message. In some embodiments, the UE may include the cell ID (e.g., the physicalCellId) of the new PSCell into the SCGFailureInformation message. In some embodiments, the UE may include the ID of the executed conditional reconfiguration (e.g., condReconfigId) into the SCGFailureInformation message. The UE may include the sk-CounterSetId associated with the new PSCell into the SCGFailureInformation message. The UE may include the measurement results in the SCGFailureInformation message.

In some embodiments, upon receiving the SCGFailureInformation message from the UE, the source node may transmit to the UE an RRC message that includes a new SK-CounterList for the new SN. Upon receiving the new SK-CounterList for the new SN, the UE may release the stored SK-CounterList corresponding to the new SN, and may store the received SK-CounterList corresponding to the new SN. Upon storing the received SK-CounterList corresponding to the new SN, the UE may select an SK-counter value from the SK-CounterList and resume the SCG transmission for all SRBs and DRBs.

### Simultaneous Configuration of CPAC and S-CPAC

In some embodiments, a UE may be simultaneously configured with one or more CPAC configurations and one or more S-CPAC configurations.

In some embodiments, if a UE is simultaneously configured with one or more CPAC configurations and one or more S-CPAC configurations, upon the execution of a CPAC configuration, the UE may release all the other stored/configured CPAC and S-CPAC configurations.

In some embodiments, if a UE is simultaneously configured with one or more CPAC configurations and one or more S-CPAC configurations, upon the execution of a CPAC configuration, the UE may release all the stored/configured CPAC and all the stored/configured S-CPAC configurations.

In some embodiments, if a UE is simultaneously configured with one or more CPAC configurations and one or more S-CPAC configurations, upon the execution of a CPAC configuration, the UE may release all the other stored/configured CPAC configurations and keep all the S-CPAC configurations.

In some embodiments, if a UE is simultaneously configured with one or more CPAC configurations and one or more S-CPAC configurations, the UE may expect that any one of the one or multiple CPAC configurations is different from any one of the one or more S-CPAC configurations.

In some embodiments, if a UE is simultaneously configured with one or more CPAC configurations and one or more S-CPAC configurations, upon the execution of a CPAC configuration, the UE may release all the stored/configured CPAC configurations and keep all the stored/configured S-CPAC configurations.

In some embodiments, if a UE is simultaneously configured with one or more CPAC configurations and one or more S-CPAC configurations, upon the execution of an S-CPAC configuration, the UE may release all the other stored/configured CPAC configurations and keep all the S-CPAC configurations.

In some embodiments, if a UE is simultaneously configured with one or more CPAC configurations and one or more S-CPAC configurations, upon the execution of an S-CPAC configuration, the UE may release all the stored/configured CPAC configurations and keep all the stored/configured S-CPAC configurations.

In some embodiments, if a UE is simultaneously configured with one or more CPAC configurations and one or more S-CPAC configurations, upon the execution of an S-CPAC configuration, the UE may keep all the CPAC and S-CPAC configurations.

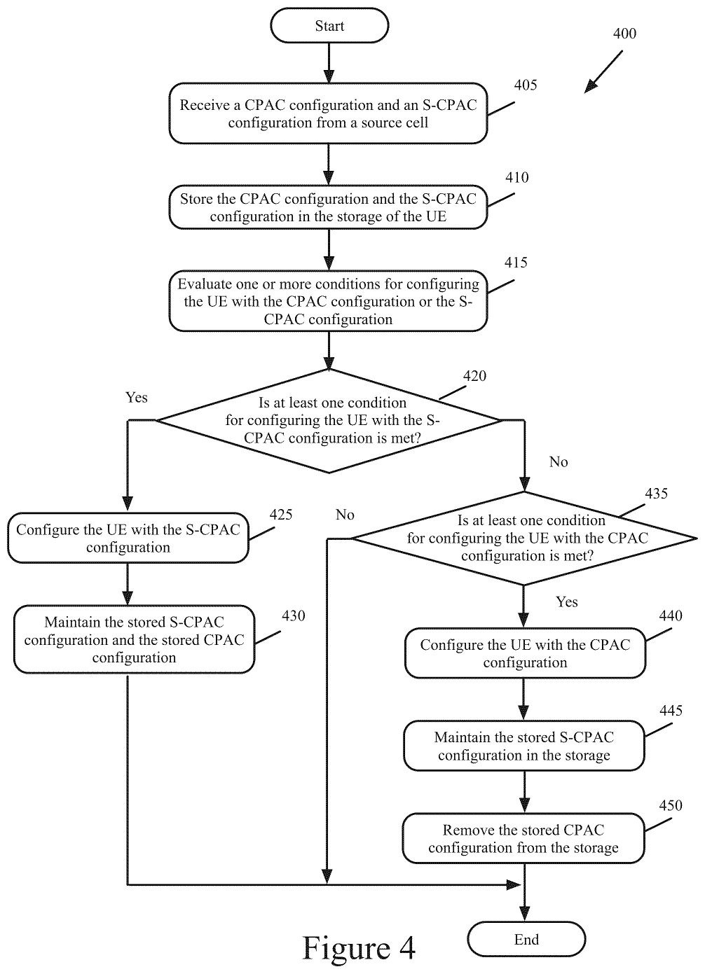

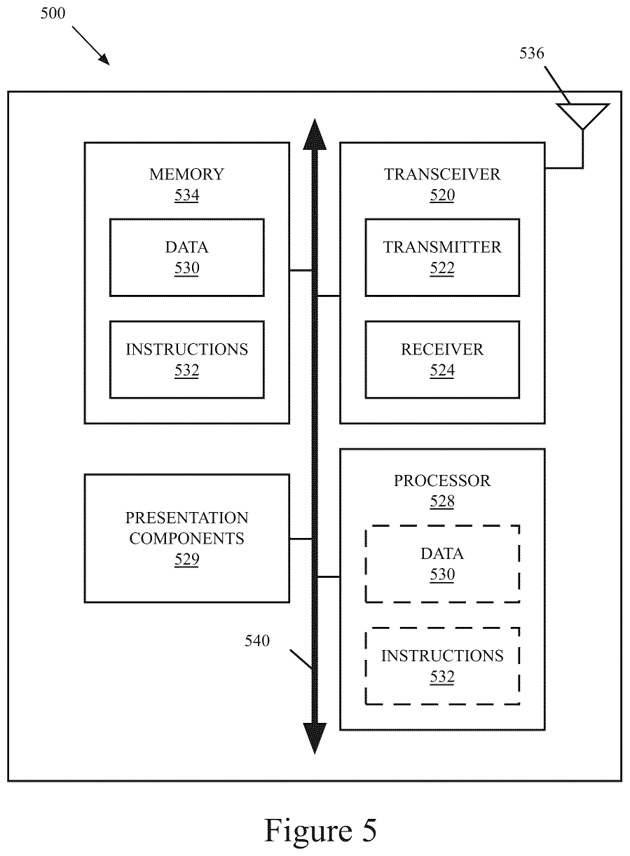

FIG. 4 is a flowchart illustrating an example method/process 400 performed by a UE for simultaneously configuring CPAC and S-CPAC, according to an example implementation of the present disclosure. With reference to FIG. 4, the process 400 may be performed by at least one processor of a UE, such as the UE 500 shown in FIG. 5.

The process 400 may receive (at block 405) a CPAC configuration and an S-CPAC configuration from a source cell. The CPAC configuration and the S-CPAC configuration, in some embodiments, may be associated with the same PSCell of an SN. In other embodiments, the CPAC configuration may be associated with a first PSCell of a first SN and the S-CPAC configuration may be associated with a second PSCell of a second SN. In some embodiments, prior to receiving the CPAC and S-CPAC configurations from the source cell, the process 400 may transmit a message to the source cell indicating that the UE is capable of being configured with both the CPAC and the S-CPAC at a same time.

The S-CPAC configuration and the CPAC configuration, in some embodiments, may be received in the same RRC message from the source cell. In other embodiments, the S-CPAC configuration and the CPAC configuration may be received from the source cell via separate RRC message. The source cell, in some embodiments, may include a PCell of an MN or a PSCell of an SN.

The process 400 may store (at block 410) the CPAC configuration and the S-CPAC configuration in the storage of the UE. The process 400 may evaluate (at block 415) one or more conditions for configuring the UE with the CPAC configuration or the S-CPAC configuration. The process 400 may determine (at block 420) as to whether at least one condition for configuring the UE with the S-CPAC configuration is met.

In a case that at least one condition for configuring the UE with the S-CPAC configuration is not met, the process 400 may proceed to block 435, which is described below. Otherwise, the process 400 may configure (at block 425) the UE with the S-CPAC configuration. The process 400 may maintain (at block 430) the stored S-CPAC configuration and the stored CPAC configuration. The process 400 may then end.

In a case that at least one condition for configuring the UE with the S-CPAC configuration is not met, the process 400 may determine (at block 435) whether at least one condition for configuring the UE with the CPAC configuration is met. If not, the process 400 may end. Otherwise, the process 400 may configure (at block 440) the UE with the CPAC configuration. For example, the UE may be configured with the CPAC configuration to support a legacy procedure. The process 400 may maintain (at block 445) the stored S-CPAC configuration in the storage. The process 400 may remove (at block 450) the stored CPAC configuration from the storage. The process 400 may then end.

### Example Embodiments

A UE, in some embodiments, may be configured with one or multiple S-CPAC configurations which may include at least a conditional reconfiguration ID (e.g., the condReconfigId), one or more execution conditions (e.g., condExecutionCond/condExecutionCondSCG), a conditional RRC configuration (e.g., condRRCReconfig) to be applied upon the execution.

The conditional RRC configuration, in some embodiments, may include an IE (e.g., the SK-CounterConfig) to indicate the information/configuration related to the SK-Counter for S-CPAC. The IE, in some embodiments, may include, at least, an IE (e.g., the SK-CounterList) that includes a list of SK-Counter IEs, and another IE (e.g., the sk-counterPointer) to indicate the index of the used SK-counter value for the current connection. In some embodiments, the IE (e.g., the SK-CounterConfig) related to the SK-counter for S-CPAC may also include an IE (e.g., the intraSNCellId) that includes a list of cell identities (e.g., the physicalCellId) and/or another IE (e.g., the intraSNCondReconfigId) that includes a list of conditional configuration IDs (e.g., the condReconfigId).

In some embodiments, upon receiving the S-CPAC configurations from the source node (e.g., the source MN/SN), the UE may store the received S-CPAC configurations. Upon executing an S-CPAC, if the cell ID (e.g., the physicalCellId) of the source PSCell is in the IE (e.g., the intraSNCellId) that includes a list of cell identities, the UE may identify an intra-SN mobility. In some embodiments, upon executing an intra-SN S-CPAC configuration, the UE may apply the same SK-Counter value as the one used for the connection to the source SN.

In some embodiments, upon executing an S-CPAC, if the cell ID (e.g., the physicalCellId) of the source PSCell is not in the IE (e.g., the intraSNCellId) that includes the list of cell identities, the UE may identify an inter-SN mobility. Upon executing an inter-SN S-CPAC configuration, the UE may apply the SK-counter value corresponding to the sk-counterPointer value, and the UE may include the sk-counterPointer value in the RRCReconfigurationComplete message and transmit the message to the source MN. After transmitting the RRCReconfigurationComplete message to the source MN, the UE may increase the stored sk-counterPointer value in each S-CPAC configuration which corresponds to the selected target SN by 1. Upon receiving the RRCReconfigurationComplete message, the source MN may forward the SN-related information, including the sk-counterPointer value, to the new SN. Upon receiving the forwarded sk-counterPointer value, the new SN may apply the SK-counter value corresponding to the sk-counterPointer value.

FIG. 5 is a block diagram illustrating a node 500 for wireless communication, according to an example implementation of the present disclosure. As illustrated in FIG. 5, a node 500 may include a transceiver 520, a processor 528, a memory 834, one or more presentation components 529, and at least one antenna 536. The node 500 may also include a radio frequency (RF) spectrum band module, a BS communications module, a network communications module, and a system communications management module, Input/Output (I/O) ports, I/O components, and a power supply (not illustrated in FIG. 5).

Each of the components may directly or indirectly communicate with each other over one or more buses 540. The node 500 may be a UE, a BS, or any other network node that performs various functions disclosed with reference to FIGS. 1 through 7.

The transceiver 520 has a transmitter 522 (e.g., transmitting/transmission circuitry) and a receiver 524 (e.g., receiving/reception circuitry) and may be configured to transmit and/or receive time and/or frequency resource partitioning information. The transceiver 520 may be configured to transmit in different types of subframes and slots including, but not limited to, usable, non-usable, and flexibly usable subframes and slot formats. The transceiver 520 may be configured to receive data and control channels.

The node 500 may include a variety of computer-readable media. Computer-readable media may be any available media that may be accessed by the node 500 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 534 may include computer-storage media in the form of volatile and/or non-volatile memory. The memory 534 may be removable, non-removable, or a combination thereof. Example memory may include solid-state memory, hard drives, optical-disc drives, etc. As illustrated in FIG. 5, the memory 534 may store a computer-readable and/or computer-executable instructions 532 (e.g., software codes) that are configured to, when executed, cause the processor 528 to perform various functions disclosed herein, for example, with reference to FIGS. 1 through 3. Alternatively, the instructions 532 may not be directly executable by the processor 528 but may be configured to cause the node 500 (e.g., when compiled and executed) to perform various functions disclosed herein.

The processor 528 (e.g., having processing circuitry) may include an intelligent hardware device, e.g., a Central Processing Unit (CPU), a microcontroller, an ASIC, etc. The processor 528 may include memory. The processor 528 may process the data 530 and the instructions 532 received from the memory 534, and information transmitted and received via the transceiver 520, the baseband communications module, and/or the network communications module. The processor 528 may also process information to send to the transceiver 520 for transmission via the antenna 536 to the network communications module for transmission to a CN.

One or more presentation components 529 may present data indications to a person or another device. Examples of presentation components 529 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain embodiments, a person of ordinary skill in the art may recognize that changes may be made in form and detail without departing from the scope of those concepts. As such, the disclosed embodiments are to be considered in all respects as illustrative and not restrictive. It should also be understood that the present disclosure is not limited to the particular embodiments disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A method for configuring a subsequent conditional primary secondary cell addition/change (S-CPAC) to a user equipment (UE), the method comprising:
receiving an S-CPAC configuration from a source cell, the S-CPAC configuration comprising a radio resource control (RRC) configuration for a primary secondary cell (PSCell) and a set of conditions for switching to the PSCell;
receiving a secondary key (SK)-counter list associated with the S-CPAC, the SK-counter list comprising one or more SK-counter entries arranged in an order in the SK-counter list;
storing the S-CPAC configuration and the SK-counter list; and
after determining that one or more conditions in the set of conditions are satisfied:
selecting a first SK-counter entry of the SK-counter list,
configuring the UE with the S-CPAC configuration to switch from another PSCell to the PSCell, wherein the first SK-counter entry is applied in configuring the UE with the S-CPAC configuration, and
removing the first SK-counter entry from the SK-counter list.

2. The method of claim 1, wherein the source cell comprises one of a primary cell (PCell) of a master node (MN) or the other PSCell of a secondary node (SN).

3. The method of claim 1, wherein receiving the SK-counter list comprises:
receiving an information element (IE) comprising the SK-counter list and an identifier (ID) that identifies the SK-counter list.

4. The method of claim 3, wherein the S-CPAC configuration and the IE are received in a same radio resource control (RRC) message.

5. The method of claim 3, wherein the S-CPAC configuration and the IE are received in separate radio resource control (RRC) messages.

6. The method of claim 1, wherein applying the first SK-counter entry in configuring the UE with the S-CPAC configuration comprises:
deriving an SK based on a value of the first SK-counter entry, wherein the UE encodes data transmitted to the PSCell and decodes data received from the PSCell using the SK.

7. The method of claim 1, wherein the S-CPAC configuration is a first S-CPAC configuration, the PSCell is a first PSCell, the set of conditions is a first set of conditions, and the SK-counter list is a first SK-counter list, the method further comprising:
receiving a second S-CPAC configuration from the source cell, the second S-CPAC configuration comprising another RRC configuration for a second PSCell and a second set of conditions for switching to the second PSCell;
receiving a second SK-counter list associated with the second S-CPAC, the second SK-counter list comprising one or more SK-counter entries arranged in the order in the second SK-counter list;
storing the second S-CPAC configuration and the second SK-counter list; and
after determining that one or more conditions in the second set of conditions are satisfied:
selecting a first SK-counter entry of the second SK-counter list,
configuring the UE with the second S-CPAC configuration to switch from the first PSCell to the second PSCell, wherein the first SK-counter entry of the second SK-counter list is applied in configuring the UE with the second S-CPAC configuration, and
removing the first SK-counter entry of the second SK-counter list from the second SK-counter list.

8. The method of claim 7, wherein the first PSCell and the second PSCell belong to two different secondary nodes (SNs).

9. The method of claim 7, further comprising:
determining that one or more conditions in the first set of conditions are satisfied;
selecting a second SK-counter entry of the first SK-counter list, wherein the second SK-counter entry is a next entry, in the order, after the removed first SK-counter entry in the first SK-counter list;
switching from the second PSCell back to the first PSCell, wherein the UE applies the second SK-counter entry of the first SK-counter list when the UE is configured back based on the first S-CPAC configuration; and
removing the second SK-counter entry of the first SK-counter list from the first SK-counter list.

10. A method for a user equipment (UE) that is capable of being configured with both a conditional primary secondary cell addition/change (CPAC) and a subsequent-CPAC (S-CPAC), the method comprising:
receiving a CPAC configuration and an S-CPAC configuration from a source cell;
storing the CPAC configuration and the S-CPAC configuration in a storage of the UE;
evaluating one or more conditions for configuring the UE with the CPAC configuration or the S-CPAC configuration;
in a case that at least one condition, from the one or more conditions, for configuring the UE with the S-CPAC configuration is met:
configuring the UE with the S-CPAC configuration, and
maintaining the stored S-CPAC configuration and the stored CPAC configuration; and
in a case that at least one other condition, from the one or more conditions, for configuring the UE with the CPAC configuration is met:
configuring the UE with the CPAC configuration,
maintaining the stored S-CPAC configuration in the storage, and
removing the stored CPAC configuration from the storage.

11. The method of claim 10, wherein the CPAC configuration and the S-CPAC configuration are associated with a same primary secondary cell (PSCell) of a secondary node (SN).

12. The method of claim 10, wherein the CPAC configuration is associated with a first primary secondary cell (PSCell) of a first secondary node (SN) and the S-CPAC configuration is associated with a second PSCell of a second SN.

13. The method of claim 10, further comprising:
prior to receiving the CPAC and S-CPAC configurations from the source cell, transmitting a message to the source cell indicating that the UE is capable of being configured with both the CPAC and the S-CPAC at a same time.

14. The method of claim 10, wherein the S-CPAC configuration and the CPAC configuration are received in a radio resource control (RRC) message from the source cell.

15. The method of claim 10, wherein the S-CPAC configuration and the CPAC configuration are received from the source cell via separate radio resource control (RRC) messages.

16. The method of claim 10, wherein the source cell comprises one of a primary cell (PCell) of a master node (MN) or a primary secondary cell (PSCell) of a secondary node (SN).

17. A user equipment (UE), comprising:
one or more non-transitory computer-readable media storing one or more computer-executable instructions for configuring a subsequent conditional primary secondary cell addition/change (S-CPAC) to the UE; and
at least one processor coupled to the one or more non-transitory computer-readable media, and configured to execute the one or more computer-executable instructions to cause the UE to:
receive an S-CPAC configuration from a source cell, the S-CPAC configuration comprising a radio resource control (RRC) configuration for a primary secondary cell (PSCell) and a set of conditions for switching to the PSCell;
receive a secondary key (SK)-counter list associated with the S-CPAC, the SK-counter list comprising one or more SK-counter entries arranged in an order in the SK-counter list;
store the S-CPAC configuration and the SK-counter list; and
after determining that one or more condition in the set of conditions are satisfied:
select a first SK-counter entry of the SK-counter list,
configure the UE with the S-CPAC configuration to switch from another PSCell to the PSCell, wherein the first SK-counter entry is applied in configuring the UE with the S-CPAC configuration, and
remove the first SK-counter entry from the SK-counter list.

18. The UE of claim 17, wherein applying the first SK-counter entry in configuring the UE with the S-CPAC configuration comprises:
deriving an SK based on a value of the first SK-counter entry, wherein the UE encodes data transmitted to the PSCell and decodes data received from the PSCell using the SK.

19. The UE of claim 17, wherein:
the S-CPAC configuration is a first S-CPAC configuration, the PSCell is a first PSCell, the set of conditions is a first set of conditions, and the SK-counter list is a first SK-counter list, and
the at least one processor is further configured to execute the one or more computer-executable instructions to cause the UE to:
receive a second S-CPAC configuration from the source cell, the second S-CPAC configuration comprising another RRC configuration for a second PSCell and a second set of conditions for switching to the second PSCell;
receive a second SK-counter list associated with the second S-CPAC, the second SK-counter list comprising one or more SK-counter entries arranged in the order in the second SK-counter list;
store the second S-CPAC configuration and the second SK-counter list; and
after determining that one or more conditions in the second set of conditions are satisfied:
select a first SK-counter entry of the second SK-counter list,
configure the UE with the second S-CPAC configuration to switch from the first PSCell to the second PSCell, wherein the first SK-counter entry of the second SK-counter list is applied in configuring the UE with the second S-CPAC configuration, and
remove the first SK-counter entry of the second SK-counter list from the second SK-counter list.

20. The UE of claim 19, wherein the at least one processor is further configured to execute the one or more computer-executable instructions to cause the UE to:
determine that one or more conditions in the first set of conditions are satisfied;
select a second SK-counter entry of the first SK-counter list, wherein the second SK-counter entry is a next entry, in the order, after the removed first SK-counter entry in the first SK-counter list;
switch from the second PSCell back to the first PSCell, wherein the UE applies the second SK-counter entry of the first SK-counter list when the UE is configured back based on the first S-CPAC configuration; and
remove the second SK-counter entry of the first SK-counter list from the first SK-counter list.
